(19) United States
(12) Patent Application Publication
(10) Pub. No.: US 2025/0386043 A1
(43) Pub. Date: Dec. 18, 2025

(54) Residual Prediction In Video Coding

(71) Applicant: Ofinno, LLC, Reston, VA (US)

(72) Inventors: Alexey Konstantinovich Filippov, Khimki (RU); Vasily Alexeevich Rufitskiy, Vladimir (RU); Esmael Hejazi Dinan, McLean, VA (US)

(73) Assignee: Ofinno, LLC, Reston, VA (US)

(21) Appl. No.: 19/303,036

(22) Filed: Aug. 18, 2025

Related U.S. Application Data
(63) Continuation of application No. PCT/US2024/016514, filed on Feb. 20, 2024.
(60) Provisional application No. 63/446,684, filed on Feb. 17, 2023.

(51) Int. Cl. H04N 19/44; H04N 19/13; H04N 19/14; H04N 19/176; H04N 19/18; H04N 19/91

(52) U.S. Cl. CPC H04N 19/44; H04N 19/13; H04N 19/14; H04N 19/176; H04N 19/18; H04N 19/91

(57) ABSTRACT

A decoder calculates a cost for each coefficient candidate of a plurality of coefficient candidates for a coefficient to be decoded. The plurality of coefficient candidates includes a first coefficient candidate and a second coefficient candidate, where a value of a magnitude symbol of the first coefficient candidate is different from a value of the magnitude symbol of the second coefficient candidate. One of the plurality of coefficient candidates is selected as a coefficient predictor based on the costs. An indication of whether a value of the magnitude symbol of the coefficient to be decoded matches a value of the corresponding magnitude symbol of the coefficient predictor is entropy decoded. The value of the magnitude symbol of the coefficient to be decoded is determined based on the indication and the value of the corresponding magnitude symbol of the coefficient predictor.

### CROSS-REFERENCE TO RELATED APPLICATIONS

This application is a continuation of International Application No. PCT/US2024/016514, filed Feb. 20, 2024, which claims the benefit of U.S. Provisional Application No. 63/446,684, filed Feb. 17, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates an exemplary video coding/decoding system in which embodiments of the present disclosure may be implemented.

FIG. 2 illustrates an exemplary encoder in which embodiments of the present disclosure may be implemented.

FIG. 3 illustrates an exemplary decoder in which embodiments of the present disclosure may be implemented.

FIG. 4 illustrates an example quadtree partitioning of a coding tree block (CTB) in accordance with embodiments of the present disclosure.

FIG. 5 illustrates a corresponding quadtree of the example quadtree partitioning of the CTB in FIG. 4 in accordance with embodiments of the present disclosure.

FIG. 6 illustrates example binary and ternary tree partitions in accordance with embodiments of the present disclosure.

FIG. 7 illustrates an example quadtree+multi-type tree partitioning of a CTB in accordance with embodiments of the present disclosure.

FIG. 8 illustrates a corresponding quadtree+multi-type tree of the example quadtree+multi-type tree partitioning of the CTB in FIG. 7 in accordance with embodiments of the present disclosure.

FIG. 9 illustrates an example set of reference samples determined for intra prediction of a current block being encoded or decoded in accordance with embodiments of the present disclosure.

FIG. 10A illustrates the 35 intra prediction modes supported by HEVC in accordance with embodiments of the present disclosure.

FIG. 10B illustrates the 67 intra prediction modes supported by HEVC in accordance with embodiments of the present disclosure.

FIG. 11 illustrates the current block and reference samples from FIG. 9 in a two-dimensional x, y plane in accordance with embodiments of the present disclosure.

FIG. 12 illustrates an example angular mode prediction of the current block from FIG. 9 in accordance with embodiments of the present disclosure.

FIG. 13A illustrates an example of inter prediction performed for a current block in a current picture being encoded in accordance with embodiments of the present disclosure.

FIG. 13B illustrates an example horizontal component and vertical component of a motion vector in accordance with embodiments of the present disclosure.

FIG. 14 illustrates an example of bi-prediction, performed for a current block in accordance with embodiments of the present disclosure.

FIG. 15A illustrates an example location of five spatial candidate neighboring blocks relative to a current block being coded in accordance with embodiments of the present disclosure.

FIG. 15B illustrates an example location of two temporal, co-located blocks relative to a current block being coded in accordance with embodiments of the present disclosure.

FIG. 16 illustrates an example of IBC applied for screen content in accordance with embodiments of the present disclosure.

FIG. 17 illustrates an example cost calculation across a block boundary of a current block.

FIG. 18 illustrates an overview of a hypothesis checking process that can be used for residual sign prediction in transform domain.

FIGS. 19A-19C illustrate an example implementation of a context-based adaptive binary arithmetic coding (CABAC) code in accordance with some embodiments of the present disclosure.

FIG. 20 illustrates coefficient group (CG) sizes for various sizes of transform blocks according to some embodiments.

FIG. 21A-21D illustrate example reverse diagonal scan patterns, according to some embodiments.

FIG. 22A illustrates example prefix and suffix parts of prefix codes for x, y coordinate transmission, according to some embodiments.

FIG. 22B shows an example set of syntax elements representing a transmission coefficient, according to some embodiments.

FIG. 23 illustrates example binarization of the absolute level values according to some example embodiments.

FIG. 24 illustrates example of the scan passes (shaded bins have zero values) organization in a context-based adaptive binary arithmetic coding (CABAC) coder according to some example embodiments.

FIGS. 25A-25B illustrate example local templates of partially reconstructed absolute levels according to some embodiments.

FIG. 26 shows an example hypotheses checking process that provides for selecting a hypothesis as the predictor, according to some embodiments.

FIGS. 27A, 27B, and 27C show examples where suffix bins of several coefficients are selected to be signaled by means of hypotheses check bins, in accordance with some embodiments.

FIG. 28A illustrates an example process for estimation of energy or magnitude of a boundary artifact in the transform domain, according to some embodiments of this disclosure.

FIG. 28B illustrates an example process for estimation of energy or magnitude of a boundary artifact in the spatial domain, according to some embodiments of this disclosure.

FIG. 29A and FIG. 29B illustrate a process of parsing a residual signal according to some embodiments.

FIG. 30A and FIG. 30B show the current Low-Frequency Non-Separable Transform (LFNST) signaling, according to some embodiments.

FIG. 31 illustrates an example process that can be performed by an encoder in accordance with some embodiments.

FIG. 32 illustrates an example process that can be performed by a decoder in accordance with some embodiments.

FIG. 33 illustrates a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Representing a video sequence in digital form may require a large number of bits. The data size of a video sequence in digital form may be too large for storage and/or transmission in many applications. Video encoding may be used to compress the size of a video sequence to provide for more efficient storage and/or transmission. Video decoding may be used to decompress a compressed video sequence for display and/or other forms of consumption.

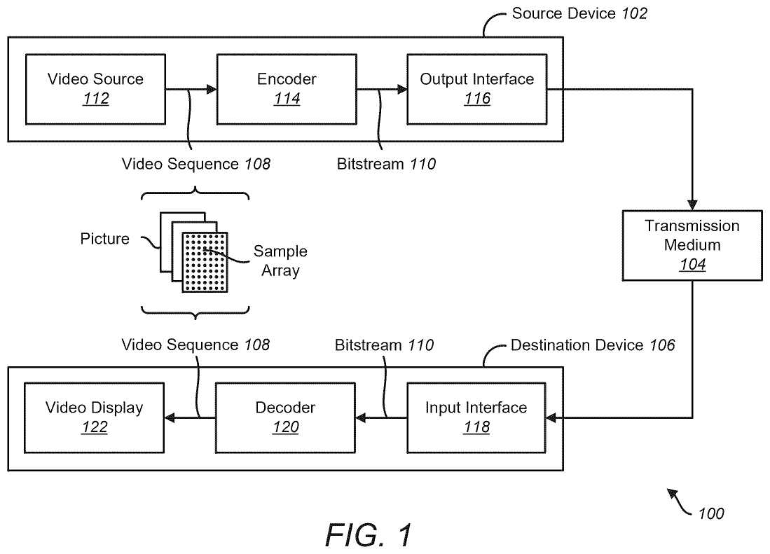

FIG. 1 illustrates an exemplary video coding/decoding system 100 in which embodiments of the present disclosure may be implemented. Video coding/decoding system 100 comprises a source device 102, a transmission medium 104, and a destination device 106. Source device 102 encodes a video sequence 108 into a bitstream 110 for more efficient storage and/or transmission. Source device 102 may store and/or transmit bitstream 110 to destination device 106 via transmission medium 104. Destination device 106 decodes bitstream 110 to display video sequence 108. Destination device 106 may receive bitstream 110 from source device 102 via transmission medium 104. Source device 102 and destination device 106 may be any one of a number of different devices, including a desktop computer, laptop computer, tablet computer, smart phone, wearable device, television, camera, video gaming console, set-top box, or video streaming device.

To encode video sequence 108 into bitstream 110, source device 102 may comprise a video source 112, an encoder 114, and an output interface 116. Video source 112 may provide or generate video sequence 108 from a capture of a natural scene and/or a synthetically generated scene. A synthetically generated scene may be a scene comprising computer generated graphics or screen content. Video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A shown in FIG. 1, a video sequence, such as video sequence 108, may comprise a series of pictures (also referred to as frames). A video sequence may achieve the impression of motion when a constant or variable time is used to successively present pictures of the video sequence. A picture may comprise one or more sample arrays of intensity values. The intensity values may be taken at a series of regularly spaced locations within a picture. A color picture typically comprises a luminance sample array and two chrominance sample arrays. The luminance sample array may comprise intensity values representing the brightness (or luma component, Y) of a picture. The chrominance sample arrays may comprise intensity values that respectively represent the blue and red components of a picture (or chroma components, Cb and Cr) separate from the brightness. Other color picture sample arrays are possible based on different color schemes (e.g., an RGB color scheme). For color pictures, a pixel may refer to all three intensity values for a given location in the three sample arrays used to represent color pictures. A monochrome picture comprises a single, luminance sample array. For monochrome pictures, a pixel may refer to the intensity value at a given location in the single, luminance sample array used to represent monochrome pictures.

Encoder 114 may encode video sequence 108 into bitstream 110. To encode video sequence 108, encoder 114 may apply one or more prediction techniques to reduce redundant information in video sequence 108. Redundant information is information that may be predicted at a decoder and therefore may not be needed to be transmitted to the decoder for accurate decoding of the video sequence. For example, encoder 114 may apply spatial prediction (e.g., intra-frame or intra prediction), temporal prediction (e.g., inter-frame prediction or inter prediction), inter-layer prediction, and/or other prediction techniques to reduce redundant information in video sequence 108. Before applying the one or more prediction techniques, encoder 114 may partition pictures of video sequence 108 into rectangular regions referred to as blocks. Encoder 114 may then encode a block using one or more of the prediction techniques.

For temporal prediction, encoder 114 may search for a block similar to the block being encoded in another picture (also referred to as a reference picture) of video sequence 108. The block determined during the search (also referred to as a prediction block) may then be used to predict the block being encoded. For spatial prediction, encoder 114 may form a prediction block based on data from reconstructed neighboring samples of the block to be encoded within the same picture of video sequence 108. A reconstructed sample refers to a sample that was encoded and then decoded. Encoder 114 may determine a prediction error (also referred to as a residual) based on the difference between a block being encoded and a prediction block. The prediction error may represent non-redundant information that may be transmitted to a decoder for accurate decoding of a video sequence.

Encoder 114 may apply a transform to the prediction error (e.g. a discrete cosine transform (DCT) to generate transform coefficients. Encoder 114 may form bitstream 110 based on the transform coefficients and other information used to determine prediction blocks (e.g., prediction types, motion vectors, and prediction modes). In some examples, encoder 114 may perform one or more of quantization and entropy coding of the transform coefficients and/or the other information used to determine prediction blocks before forming bitstream 110 to further reduce the number of bits needed to store and/or transmit video sequence 108.

Output interface 116 may be configured to write and/or store bitstream 110 onto transmission medium 104 for transmission to destination device 106. In addition or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one more networks (e.g., the Internet) or file servers configured to store and/or transmit encoded video data.

To decode bitstream 110 into video sequence 108 for display, destination device 106 may comprise an input interface 118, a decoder 120, and a video display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above.

Decoder 120 may decode video sequence 108 from encoded bitstream 110. To decode video sequence 108, decoder 120 may generate prediction blocks for pictures of video sequence 108 in a similar manner as encoder 114 and determine prediction errors for the blocks. Decoder 120 may generate the prediction blocks using prediction types, prediction modes, and/or motion vectors received in bitstream 110 and determine the prediction errors using transform coefficients also received in bitstream 110. Decoder 120 may determine the prediction errors by weighting transform basis functions using the transform coefficients. Decoder 120 may combine the prediction blocks and prediction errors to decode video sequence 108. In some examples, decoder 120 may decode a video sequence that approximates video sequence 108 due to, for example, lossy compression of video sequence 108 by encoder 114 and/or errors introduced into encoded bitstream 110 during transmission to destination device 106.

Video display 122 may display video sequence 108 to a user. Video display 122 may comprise a cathode rate tube (CRT) display, liquid crystal display (LCD), a plasma display, light emitting diode (LED) display, or any other display device suitable for displaying video sequence 108.

It should be noted that video encoding/decoding system 100 is presented by way of example and not limitation. In the example of FIG. 1, video encoding/decoding system 100 may have other components and/or arrangements. For example, video source 112 may be external to source device 102. Similarly, video display 122 may be external to destination device 106 or omitted altogether where video sequence is intended for consumption by a machine and/or storage device. In another example, source device 102 may further comprise a video decoder and destination device 106 may comprise a video encoder. In such an example, source device 102 may be configured to further receive an encoded bitstream from destination device 106 to support two-way video transmission between the devices.

In the example of FIG. 1, encoder 114 and decoder 120 may operate according to any one of a number of proprietary or industry video coding standards. For example, encoder 114 and decoder 120 may operate according to one or more of International Telecommunications Union Telecommunication Standardization Sector (ITU-T) H.263, ITU-T H.264 and Moving Picture Expert Group (MPEG)-4 Visual (also known as Advanced Video Coding (AVC), ITU-T H.265 and MPEG-H Part 2 (also known as High Efficiency Video Coding (HEVC), ITU-T H.265 and MPEG-I Part 3 (also known as Versatile Video Coding (VVC)), the WebM VP8 and VP9 codecs, and AOMedia Video 1 (AV1).

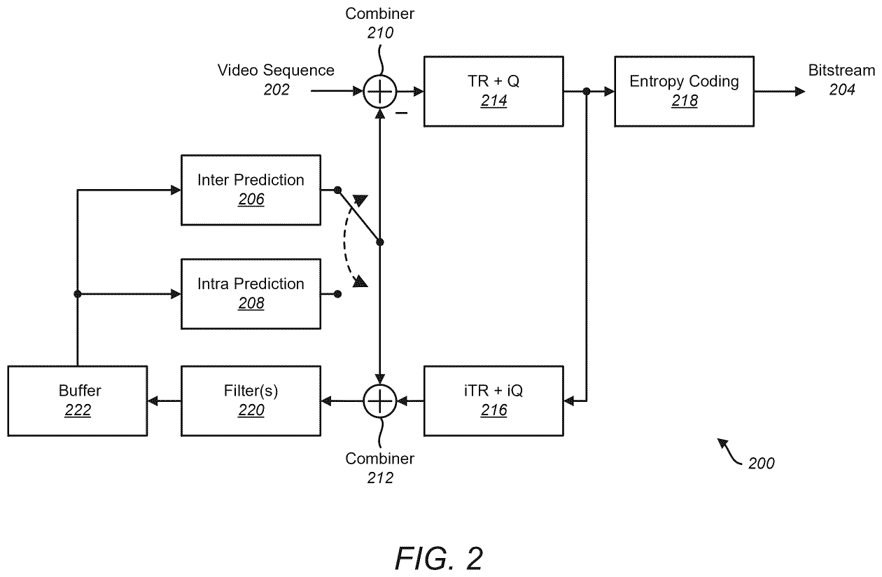

FIG. 2 illustrates an exemplary encoder 200 in which embodiments of the present disclosure may be implemented. Encoder 200 encodes a video sequence 202 into a bitstream 204 for more efficient storage and/or transmission. Encoder 200 may be implemented in video coding/decoding system 100 in FIG. 1 or in any one of a number of different devices, including a desktop computer, laptop computer, tablet computer, smart phone, wearable device, television, camera, video gaming console, set-top box, or video streaming device. Encoder 200 comprises an inter prediction unit 206, an intra prediction unit 208, combiners 210 and 212, a transform and quantization unit (TR+Q) unit 214, an inverse transform and quantization unit (iTR+iQ) 216, entropy coding unit 218, one or more filters 220, and a buffer 222.

Encoder 200 may partition the pictures of video sequence 202 into blocks and encode video sequence 202 on a block-by-block basis. Encoder 200 may perform a prediction technique on a block being encoded using either inter prediction unit 206 or intra prediction unit 208. Inter prediction unit 206 may perform inter prediction by searching for a block similar to the block being encoded in another, reconstructed picture (also referred to as a reference picture) of video sequence 202. A reconstructed picture refers to a picture that was encoded and then decoded. The block determined during the search (also referred to as a prediction block) may then be used to predict the block being encoded to remove redundant information. Inter prediction unit 206 may exploit temporal redundancy or similarities in scene content from picture to picture in video sequence 202 to determine the prediction block. For example, scene content between pictures of video sequence 202 may be similar except for differences due to motion or affine transformation of the screen content over time.

Intra prediction unit 208 may perform intra prediction by forming a prediction block based on data from reconstructed neighboring samples of the block to be encoded within the same picture of video sequence 202. A reconstructed sample refers to a sample that was encoded and then decoded. Intra prediction unit 208 may exploit spatial redundancy or similarities in scene content within a picture of video sequence 202 to determine the prediction block. For example, the texture of a region of scene content in a picture may be similar to the texture in the immediate surrounding area of the region of the scene content in the same picture.

After prediction, combiner 210 may determine a prediction error (also referred to as a residual) based on the difference between the block being encoded and the prediction block. The prediction error may represent non-redundant information that may be transmitted to a decoder for accurate decoding of a video sequence.

Transform and quantization unit 214 may transform and quantize the prediction error. Transform and quantization unit 214 may transform the prediction error into transform coefficients by applying, for example, a DCT to reduce correlated information in the prediction error. Transform and quantization unit 214 may quantize the coefficients by mapping data of the transform coefficients to a predefined set of representative values. Transform and quantization unit 214 may quantize the coefficients to reduce irrelevant information in bitstream 204. Irrelevant information is information that may be removed from the coefficients without producing visible and/or perceptible distortion in video sequence 202 after decoding.

Entropy coding unit 218 may apply one or more entropy coding methods to the quantized transform coefficients to further reduce the bit rate. For example, entropy coding unit 218 may apply context adaptive variable length coding (CAVLC), context adaptive binary arithmetic coding (CABAC), and syntax-based context-based binary arithmetic coding (SBAC). The entropy coded coefficients are packed to form bitstream 204.

Inverse transform and quantization unit 216 may inverse quantize and inverse transform the quantized transform coefficients to determine a reconstructed prediction error. Combiner 212 may combine the reconstructed prediction error with the prediction block to form a reconstructed block. Filter(s) 220 may filter the reconstructed block using, for example, a deblocking filter and/or a sample-adaptive offset (SAO) filter. Buffer 222 may store the reconstructed block for prediction of one or more other blocks in the same and/or different picture of video sequence 202.

Although not shown in FIG. 2, encoder 200 further comprises an encoder control unit configured to control one or more of the units of encoder 200 shown in FIG. 2. The encoder control unit may control the one or more units of encoder 200 such that bitstream 204 is generated in conformance with the requirements of any one of a number of proprietary or industry video coding standards. For example, The encoder control unit may control the one or more units of encoder 200 such that bitstream 204 is generated in conformance with one or more of ITU-T H.263, AVC, HEVC, VVC, VP8, VP9, and AV1 video coding standards.

Within the constraints of a proprietary or industry video coding standard, the encoder control unit may attempt to minimize or reduce the bitrate of bitstream 204 and maximize or increase the reconstructed video quality. For example, the encoder control unit may attempt to minimize or reduce the bitrate of bitstream 204 given a level that the reconstructed video quality may not fall below, or attempt to maximize or increase the reconstructed video quality given a level that the bit rate of bitstream 204 may not exceed. The encoder control unit may determine/control one or more of: partitioning of the pictures of video sequence 202 into blocks, whether a block is inter predicted by inter prediction unit 206 or intra predicted by intra prediction unit 208, a motion vector for inter prediction of a block, an intra prediction mode among a plurality of intra prediction modes for intra prediction of a block, filtering performed by filter(s) 220, and one or more transform types and/or quantization parameters applied by transform and quantization unit 214. The encoder control unit may determine/control the above based on how the determination/control effects a rate-distortion measure for a block or picture being encoded. The encoder control unit may determine/control the above to reduce the rate-distortion measure for a block or picture being encoded.

After being determined, the prediction type used to encode a block (intra or inter prediction), prediction information of the block (intra prediction mode if intra predicted, motion vector, etc.), and transform and quantization parameters, may be sent to entropy coding unit 218 to be further compressed to reduce the bit rate. For example, entropy coding unit 218 may apply context adaptive variable length coding (CAVLC), context adaptive binary arithmetic coding (CABAC), and syntax-based context-based binary arithmetic coding (SBAC) to compress the prediction type used to encode a block (intra or inter prediction), prediction information of the block (intra prediction mode if intra predicted, motion vector, etc.), and transform and quantization parameters. The prediction type, prediction information, and transform and quantization parameters may be packed with the prediction error to form bitstream 204.

It should be noted that encoder 200 is presented by way of example and not limitation. In other examples, encoder 200 may have other components and/or arrangements. For example, one or more of the components shown in FIG. 2 may be optionally included in encoder 200, such as entropy coding unit 218 and filters(s) 220.

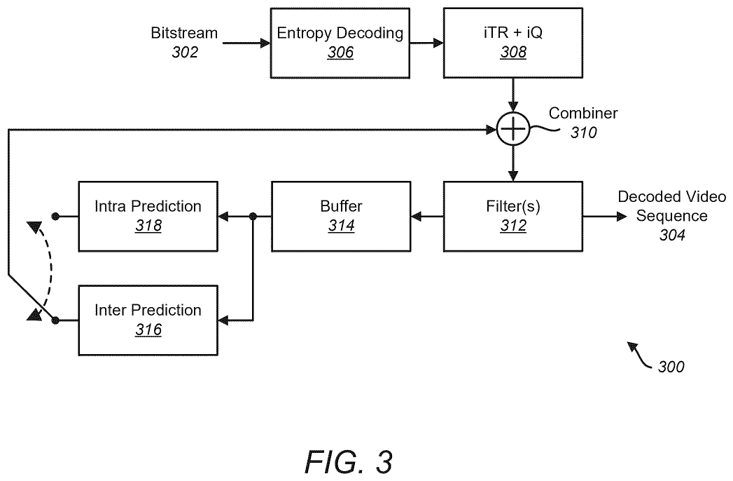

FIG. 3 illustrates an exemplary decoder 300 in which embodiments of the present disclosure may be implemented. Decoder 300 decodes a bitstream 302 into a decoded video sequence 304 for display and/or some other form of consumption. Decoder 300 may be implemented in video coding/decoding system 100 in FIG. 1 or in any one of a number of different devices, including a desktop computer, laptop computer, tablet computer, smart phone, wearable device, television, camera, video gaming console, set-top box, or video streaming device. Decoder 300 comprises an entropy decoding unit 306, an inverse transform and quantization (iTR+iQ) unit 308, a combiner 310, one or more filters 312, a buffer 314, an inter prediction unit 316, and an intra prediction unit 318.

Although not shown in FIG. 3, decoder 300 further comprises a decoder control unit configured to control one or more of the units of decoder 300 shown in FIG. 3. The decoder control unit may control the one or more units of decoder 300 such that bitstream 302 is decoded in conformance with the requirements of any one of a number of proprietary or industry video coding standards. For example, The decoder control unit may control the one or more units of decoder 300 such that bitstream 302 is decoded in conformance with one or more of ITU-T H.263, AVC, HEVC, VVC, VP8, VP9, and AV1 video coding standards.

The decoder control unit may determine/control one or more of: whether a block is inter predicted by inter prediction unit 316 or intra predicted by intra prediction unit 318, a motion vector for inter prediction of a block, an intra prediction mode among a plurality of intra prediction modes for intra prediction of a block, filtering performed by filter(s) 312, and one or more inverse transform types and/or inverse quantization parameters to be applied by inverse transform and quantization unit 308. One or more of the control parameters used by the decoder control unit may be packed in bitstream 302.

Entropy decoding unit 306 may entropy decode the bitstream 302. For example, entropy decoding unit 306 may apply context adaptive variable length coding (CAVLC), context adaptive binary arithmetic coding (CABAC), and syntax-based context-based binary arithmetic coding (SBAC) to decompress the prediction type used to encode a block (intra or inter prediction), prediction information of the block (intra prediction mode if intra predicted, motion vector, etc.), and transform and quantization parameters. Inverse transform and quantization unit 308 may inverse quantize and inverse transform the quantized transform coefficients to determine a decoded prediction error. Combiner 310 may combine the decoded prediction error with a prediction block to form a decoded block. The prediction block may be generated by intra prediction unit 318 or inter prediction unit 316 as described above with respect to encoder 200 in FIG. 2. Filter(s) 312 may filter the decoded block using, for example, a deblocking filter and/or a sample-adaptive offset (SAO) filter. Buffer 314 may store the decoded block for prediction of one or more other blocks in the same and/or different picture of the video sequence in bitstream 302. Decoded video sequence 304 may be output from filter(s) 312 as shown in FIG. 3.

It should be noted that decoder 300 is presented by way of example and not limitation. In other examples, decoder 300 may have other components and/or arrangements. For example, one or more of the components shown in FIG. 3 may be optionally included in decoder 300, such as entropy decoding unit 306 and filters(s) 312.

It should be further noted that, although not shown in FIGS. 2 and 3, each of encoder 200 and decoder 300 may further comprise an intra block copy unit in addition to inter prediction and intra prediction units. The intra block copy unit may perform similar to an inter prediction unit but predict blocks within the same picture. For example, the intra block copy unit may exploit repeated patterns that appear in screen content. Screen content may include, for example, computer generated text, graphics, and animation.

As mentioned above, video encoding and decoding may be performed on a block-by-block basis. The process of partitioning a picture into blocks may be adaptive based on the content of the picture. For example, larger block partitions may be used in areas of a picture with higher levels of homogeneity to improve coding efficiency.

In HEVC, a picture may be partitioned into non-overlapping square blocks, referred to as coding tree blocks (CTBs), comprising samples of a sample array. A CTB may have a size of 2n×2n samples, where n may be specified by a parameter of the encoding system. For example, n may be 4, 5, or 6. A CTB may be further partitioned by a recursive quadtree partitioning into coding blocks (CBs) of half vertical and half horizontal size. The CTB forms the root of the quadtree. A CB that is not split further as part of the recursive quadtree partitioning may be referred to as a leaf-CB of the quadtree and otherwise as a non-leaf CB of the quadtree. A CB may have a minimum size specified by a parameter of the encoding system. For example, a CB may have a minimum size of 4×4, 8×8, 16×16, 32×32, or 64×64 samples. For inter and intra prediction, a CB may be further partitioned into one or more prediction blocks (PBs) for performing inter and intra prediction. A PB may be a rectangular block of samples on which the same prediction type/mode may be applied. For transformations, a CB may be partitioned into one or more transform blocks (TBs). A TB may be a rectangular block of samples that may determine an applied transform size.

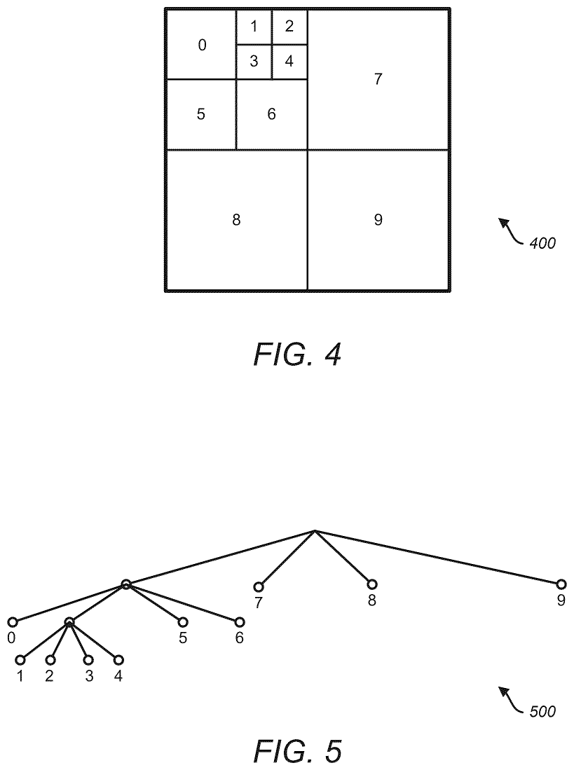

FIG. 4 illustrates an example quadtree partitioning of a CTB 400. FIG. 5 illustrates a corresponding quadtree 500 of the example quadtree partitioning of CTB 400 in FIG. 4. As shown in FIGS. 4 and 5, CTB 400 is first partitioned into four CBs of half vertical and half horizontal size. Three of the resulting CBs of the first level partitioning of CTB 400 are leaf-CBs. The three leaf CBs of the first level partitioning of CTB 400 are respectively labeled 7, 8, and 9 in FIGS. 4 and 5. The non-leaf CB of the first level partitioning of CTB 400 is partitioned into four sub-CBs of half vertical and half horizontal size. Three of the resulting sub-CBs of the second level partitioning of CTB 400 are leaf CBs. The three leaf CBs of the second level partitioning of CTB 400 are respectively labeled 0, 5, and 6 in FIGS. 4 and 5. Finally, the non-leaf CB of the second level partitioning of CTB 400 is partitioned into four leaf CBs of half vertical and half horizontal size. The four leaf CBs are respectively labeled 1, 2, 3, and 4 in FIGS. 4 and 5.

Altogether, CTB 400 is partitioned into 10 leaf CBs respectively labeled 0-9. The resulting quadtree partitioning of CTB 400 may be scanned using a z-scan (left-to-right, top-to-bottom) to form the sequence order for encoding/decoding the CB leaf nodes. The numeric label of each CB leaf node in FIGS. 4 and 5 may correspond to the sequence order for encoding/decoding, with CB leaf node 0 encoded/decoded first and CB leaf node 9 encoded/decoded last. Although not shown in FIGS. 4 and 5, it should be noted that each CB leaf node may comprise one or more PBs and TBs.

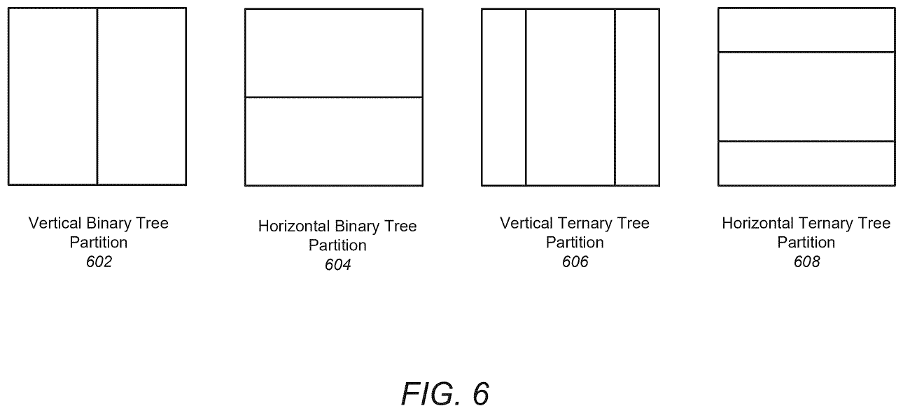

In VVC, a picture may be partitioned in a similar manner as in HEVC. A picture may be first partitioned into non-overlapping square CTBs. The CTBs may then be partitioned by a recursive quadtree partitioning into CBs of half vertical and half horizontal size. In VVC, a quadtree leaf node may be further partitioned by a binary tree or ternary tree partitioning into CBs of unequal sizes. FIG. 6 illustrates example binary and ternary tree partitions. A binary tree partition may divide a parent block in half in either the vertical direction 602 or horizontal direction 604. The resulting partitions may be half in size as compared to the parent block. A ternary tree partition may divide a parent block into three parts in either the vertical direction 606 or horizontal direction 608. The middle partition may be twice as large as the other two end partitions in a ternary tree partition.

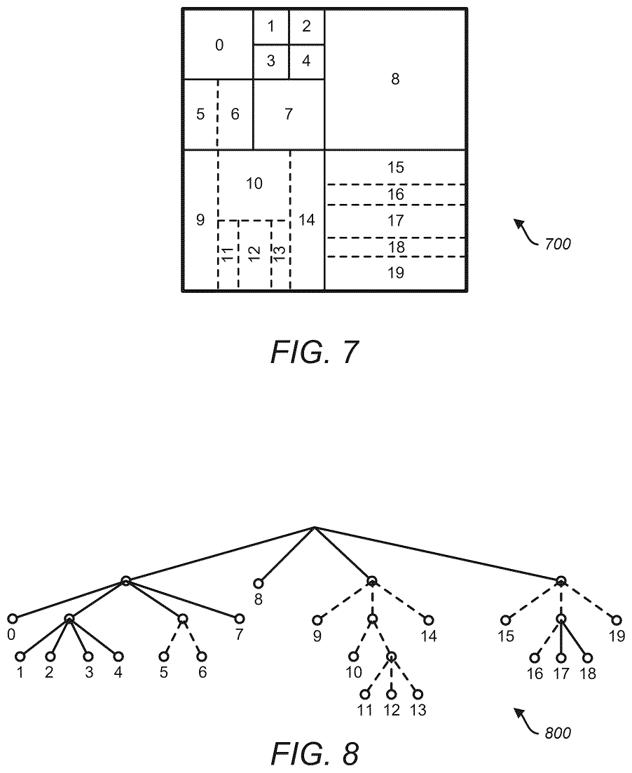

Because of the addition of binary and ternary tree partitioning, in VVC the block partitioning strategy may be referred to as quadtree+multi-type tree partitioning. FIG. 7 illustrates an example quadtree+multi-type tree partitioning of a CTB 700. FIG. 8 illustrates a corresponding quadtree+multi-type tree 800 of the example quadtree+multi-type tree partitioning of CTB 700 in FIG. 7. In both FIGS. 7 and 8, quadtree splits are shown in solid lines and multi-type tree splits are shown in dashed lines. For ease of explanation, CTB 700 is shown with the same quadtree partitioning as CTB 400 described in FIG. 4. Therefore, description of the quadtree partitioning of CTB 700 is omitted. The description of the additional multi-type tree partitions of CTB 700 is made relative to three leaf-CBs shown in FIG. 4 that have been further partitioned using one or more binary and ternary tree partitions. The three leaf-CBs in FIG. 4 that are shown in FIG. 7 as being further partitioned are leaf-CBs 5, 8, and 9.

Starting with leaf-CB 5 in FIG. 4, FIG. 7 shows this leaf-CB partitioned into two CBs based on a vertical binary tree partitioning. The two resulting CBs are leaf-CBs respectively labeled 5 and 6 in FIGS. 7 and 8. With respect to leaf-CB 8 in FIG. 4, FIG. 7 shows this leaf-CB partitioned into three CBs based on a vertical ternary tree partition. Two of the three resulting CBs are leaf-CBs respectively labeled 9 and 14 in FIGS. 7 and 8. The remaining, non-leaf CB is partitioned first into two CBs based on a horizontal binary tree partition, one of which is a leaf-CB labeled 10 and the other of which is further partitioned into three CBs based on a vertical ternary tree partition. The resulting three CBs are leaf-CBs respectively labeled 11, 12, and 13 in FIGS. 7 and 8. Finally, with respect to leaf-CB 9 in FIG. 4, FIG. 7 shows this leaf-CB partitioned into three CBs based on a horizontal ternary tree partition. Two of the three CBs are leaf-CBs respectively labeled 15 and 19 in FIGS. 7 and 8. The remaining, non-leaf CB is partitioned into three CBs based on another horizontal ternary tree partition. The resulting three CBs are all leaf-CBs respectively labeled 16, 17, and 18 in FIGS. 7 and 8.

Altogether, CTB 700 is partitioned into 20 leaf CBs respectively labeled 0-19. The resulting quadtree+multi-type tree partitioning of CTB 700 may be scanned using a z-scan (left-to-right, top-to-bottom) to form the sequence order for encoding/decoding the CB leaf nodes. The numeric label of each CB leaf node in FIGS. 7 and 8 may correspond to the sequence order for encoding/decoding, with CB leaf node 0 encoded/decoded first and CB leaf node 19 encoded/decoded last. Although not shown in FIGS. 7 and 8, it should be noted that each CB leaf node may comprise one or more PBs and TBs.

In addition to specifying various blocks (e.g., CTB, CB, PB, TB), HEVC and VVC further define various units. While blocks may comprise a rectangular area of samples in a sample array, units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bitstream. A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

It should be noted that the term block may be used to refer to any of a CTB, CB, PB, TB, CTU, CU, PU, or TU in the context of HEVC and VVC. It should be further noted that the term block may be used to refer to similar data structures in the context of other video coding standards. For example, the term block may refer to a macroblock in AVC, a macroblock or sub-block in VP8, a superblock or sub-block in VP9, or a superblock or sub-block in AV1.

In intra prediction, samples of a block to be encoded (also referred to as the current block) may be predicted from samples of the column immediately adjacent to the left-most column of the current block and samples of the row immediately adjacent to the top-most row of the current block. The samples from the immediately adjacent column and row may be jointly referred to as reference samples. Each sample of the current block may be predicted by projecting the position of the sample in the current block in a given direction (also referred to as an intra prediction mode) to a point along the reference samples. The sample may be predicted by interpolating between the two closest reference samples of the projection point if the projection does not fall directly on a reference sample. A prediction error (also referred to as a residual) may be determined for the current block based on differences between the predicted sample values and the original sample values of the current block.

At an encoder, this process of predicting samples and determining a prediction error based on a difference between the predicted samples and original samples may be performed for a plurality of different intra prediction modes, including non-directional intra prediction modes. The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block using the intra prediction mode indicated by the encoder and combining the predicted samples with the prediction error.

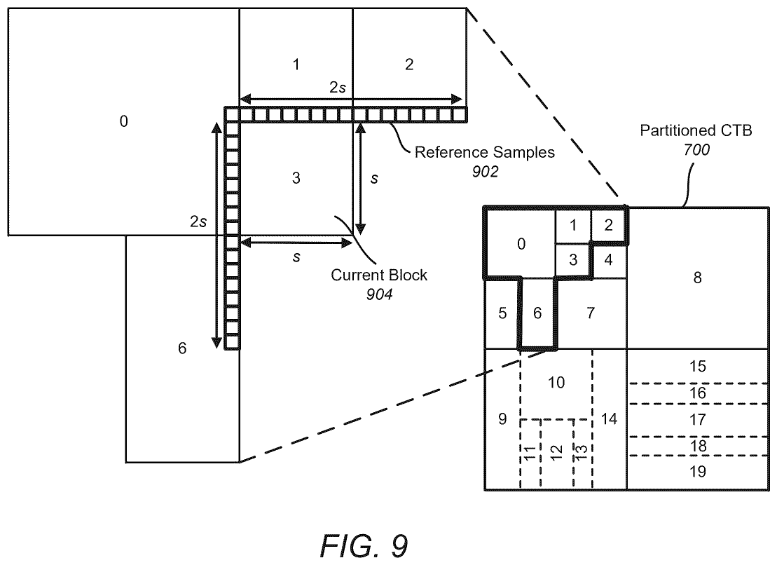

FIG. 9 illustrates an example set of reference samples 902 determined for intra prediction of a current block 904 being encoded or decoded. In FIG. 9, current block 904 corresponds to block 3 of partitioned CTB 700 in FIG. 7. As explained above, the numeric labels 0-19 of the blocks of partitioned CTB 700 may correspond to the sequence order for encoding/decoding the blocks and are used as such in the example of FIG. 9.

Given current block 904 is of w×h samples in size, reference samples 902 may extend over 2 w samples of the row immediately adjacent to the top-most row of current block 904, 2h samples of the column immediately adjacent to the left-most column of current block 904, and the top left neighboring corner sample to current block 904. In the example of FIG. 9, current block 904 is square, so w=h=s. For constructing the set of reference samples 902, available samples from neighboring blocks of current block 904 may be used. Samples may not be available for constructing the set of reference samples 902 if, for example, the samples would lie outside the picture of the current block, the samples are part of a different slice of the current block (where the concept of slices are used), and/or the samples belong to blocks that have been inter coded and constrained intra prediction is indicated. When constrained intra prediction is indicated, intra prediction may not be dependent on inter predicted blocks.

In addition to the above, samples that may not be available for constructing the set of reference samples 902 include samples in blocks that have not already been encoded and reconstructed at an encoder or decoded at a decoder based on the sequence order for encoding/decoding. This restriction may allow identical prediction results to be determined at both the encoder and decoder. In FIG. 9, samples from neighboring blocks 0, 1, and 2 may be available to construct reference samples 902 given that these blocks are encoded and reconstructed at an encoder and decoded at a decoder prior to coding of current block 904. This assumes there are no other issues, such as those mentioned above, preventing the availability of samples from neighboring blocks 0, 1, and 2. However, the portion of reference samples 902 from neighboring block 6 may not be available due to the sequence order for encoding/decoding.

Unavailable ones of reference samples 902 may be filled with available ones of reference samples 902. For example, an unavailable reference sample may be filled with a nearest available reference sample determined by moving in a clock-wise direction through reference samples 902 from the position of the unavailable reference. If no reference samples are available, reference samples 902 may be filled with the mid-value of the dynamic range of the picture being coded.

It should be noted that reference samples 902 may be filtered based on the size of current block 904 being coded and an applied intra prediction mode. It should be further noted that FIG. 9 illustrates only one exemplary determination of reference samples for intra prediction of a block. In some proprietary and industry video coding standards, reference samples may be determined in a different manner than discussed above. For example, multiple reference lines may be used in other instances, such as used in VVC.

After reference samples 902 are determined and optionally filtered, samples of current block 904 may be intra predicted based on reference samples 902. Most encoders/decoders support a plurality of intra prediction modes in accordance with one or more video coding standards. For example, HEVC supports 35 intra prediction modes, including a planar mode, a DC mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture.

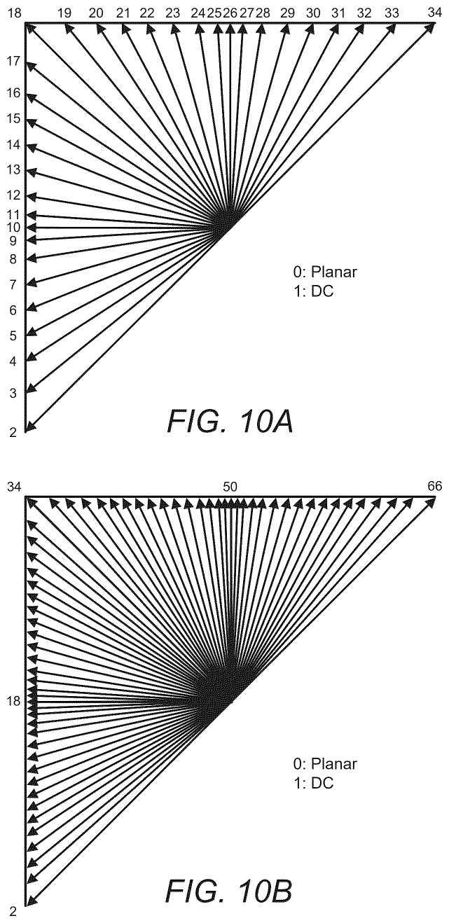

FIG. 10A illustrates the 35 intra prediction modes supported by HEVC. The 35 intra prediction modes are identified by indices 0 to 34. Prediction mode 0 corresponds to planar mode. Prediction mode 1 corresponds to DC mode. Prediction modes 2-34 correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B illustrates the 67 intra prediction modes supported by VVC. The 67 intra prediction modes are identified by indices 0 to 66. Prediction mode 0 corresponds to planar mode. Prediction mode 1 corresponds to DC mode. Prediction modes 2-66 correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Because blocks in VVC may be non-square, some of the intra prediction modes illustrated in FIG. 10B may be adaptively replaced by wide-angle directions.

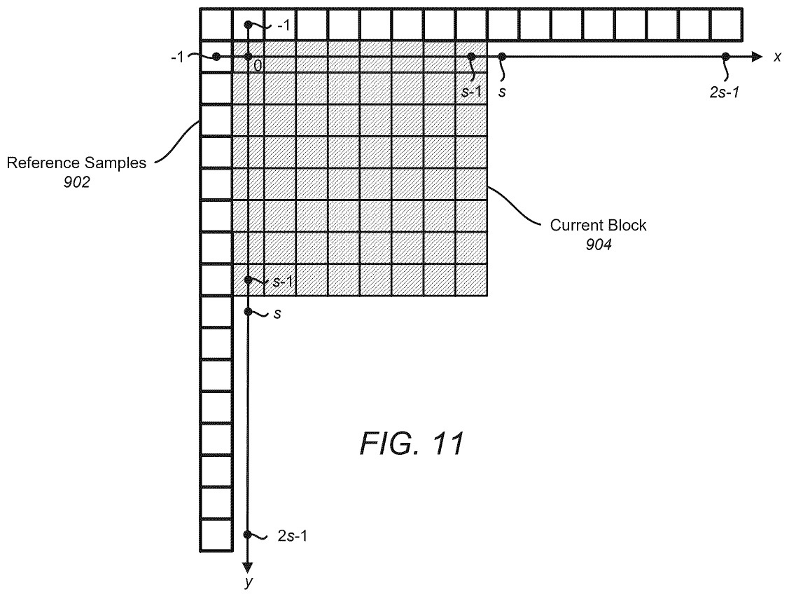

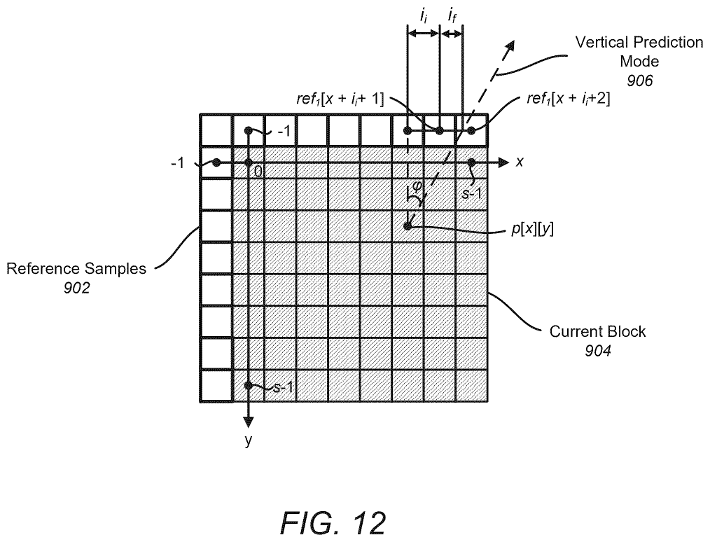

To further describe the application of intra prediction modes to determine a prediction of a current block, reference is made to FIGS. 11 and 12. In FIG. 11, current block 904 and reference samples 902 from FIG. 9 are shown in a two-dimensional x, y plane, where a sample may be referenced as p[x][y]. In order to simplify the prediction process, reference samples 902 may be placed in two, one-dimensional arrays. Reference samples 902 above current block 904 may be placed in the one-dimensional array ref₁[x]:

$$r e {f}_{1} [ x ] = p [ - 1 + x ] [ - 1 ] , ( x \geq 0 ) \qquad ( 1 )$$

Reference samples 902 to the left of current block 904 may be placed in the one-dimensional array ref₂[x]:

$$r e {f}_{2} [ y ] = p [ - 1 ] [ - 1 + y ] , ( y \geq 0 ) \qquad ( 2 )$$

For planar mode, a sample at location [x][y] in current block 904 may be predicted by calculating the mean of two interpolated values. The first of the two interpolated values may be based on a horizontal linear interpolation at location [x][y] in current block 904. The second of the two interpolated values may be based on a vertical linear interpolation at location [x][y] in current block 904. The predicted sample p[x][y] in current block 904 may be calculated as

$$p [ x ] [ y ] = \frac{1}{2 \cdot s} ( h [ x ] [ y ] + v [ x ] [ y ] + s ) \qquad ( 3 )$$

$$where$$

$$h [ x ] [ y ] = ( s - x - 1 ) \cdot {ref}_{2} [ y ] + ( x + 1 ) \cdot {ref}_{1} [ s ] \qquad ( 4 )$$

may be the horizonal linear interpolation at location [x][y] in current block 904 and

$$v [ x ] [ y ] = ( s - y - 1 ) \cdot {ref}_{1} [ x ] + ( y + 1 ) \cdot {ref}_{2} [ s ] \qquad ( 5 )$$

may be the vertical linear interpolation at location [x][y] in current block 904.

For DC mode, a sample at location [x][y] in current block 904 may be predicted by the mean of the reference samples 902. The predicted value sample p[x][y] in current block 904 may be calculated as

$$p [ x ] [ y ] = \frac{1}{2 \cdot s} ( {\sum }_{x = 0}^{s - 1} {ref}_{1} [ x ] + {\sum }_{y = 0}^{s - 1} {ref}_{2} [ y ] ) \qquad ( 6 )$$

For angular modes, a sample at location [x][y] in current block 904 may be predicted by projecting the location [x][y] in a direction specified by a given angular mode to a point on the horizontal or vertical line of samples comprising reference samples 902. The sample at location [x][y] may be predicted by interpolating between the two closest reference samples of the projection point if the projection does not fall directly on a reference sample. The direction specified by the angular mode may be given by an angle φ defined relative to the y-axis for vertical prediction modes (e.g., modes 19-34 in HEVC and modes 35-66 in VVC) and relative to the x-axis for horizontal prediction modes (e.g., modes 2-18 in HEVC and modes 2-34 in VVC).

FIG. 12 illustrates a prediction of a sample at location [x][y] in current block 904 for a vertical prediction mode 906 given by an angle φ. For vertical prediction modes, the location [x][y] in current block 904 is projected to a point (referred to herein as the “projection point”) on the horizontal line of reference samples ref₁[x]. Reference samples 902 are only partially shown in FIG. 12 for ease of illustration. Because the projection point falls at a fractional sample position between two reference samples in the example of FIG. 12, the predicted sample p[x][y] in current block 904 may be calculated by linearly interpolating between the two reference samples as follows:

$$p [ x ] [ y ] = ( 1 - {i}_{f} ) \cdot {ref}_{1} [ x + {i}_{i} + 1 ] + {i}_{f} \cdot {ref}_{1} [ x + {i}_{i} + 2 ] \qquad ( 7 )$$

where iᵢ is the integer part of the horizontal displacement of the projection point relative to the location [x][y] and may calculated as a function of the tangent of the angle φ of the vertical prediction mode 906 as follows

$${i}_{i} = ⌊ ( y + 1 ) \cdot tan φ ⌋ , \qquad ( 8 )$$

and i_{f} is the fractional part of the horizontal displacement of the projection point relative to the location [x][y] and may be calculated as

$${i}_{f} = ( ( y + 1 ) \cdot tan φ ) - ⌊ ( y + 1 ) \cdot tan φ ⌋ . \qquad ( 9 )$$

where └⋅┘ is the integer floor.

For horizontal prediction modes, the position [x][y] of a sample in current block 904 may be projected onto the vertical line of reference samples ref₂[y]. Sample prediction for horizontal prediction modes is given by:

$$p [ x ] [ y ] = ( 1 - {i}_{f} ) \cdot {ref}_{2} [ x + {i}_{i} + 1 ] + {i}_{f} \cdot {ref}_{2} [ x + {i}_{i} + 2 ] \qquad ( 10 )$$

where iᵢ is the integer part of the vertical displacement of the projection point relative to the location [x][y] and may be calculated as a function of the tangent of the angle φ of the horizontal prediction mode as follows

$${i}_{i} = ⌊ ( x + 1 ) \cdot tan φ ⌋ , \qquad ( 11 )$$

and i_{f} is the fractional part of the vertical displacement of the projection point relative to the location [x][y] and may be calculated as

$${i}_{f} = ( ( x + 1 ) \cdot tan φ ) - ⌊ ( x + 1 ) \cdot tan φ ⌋ . \qquad ( 12 )$$

where └⋅┘ is the integer floor.

The interpolation functions of (7) and (10) may be implemented by an encoder or decoder, such as encoder 200 in FIG. 2 or decoder 300 in FIG. 3, as a set of two-tap finite impulse response (FIR) filters. The coefficients of the two-tap FIR filters may be respectively given by (1−i_{f}) and i_{f}. In the above angular intra prediction examples, the predicted sample p[x][y] may be calculated with some predefined level of sample accuracy, such as 1/32 sample accuracy. For 1/32 sample accuracy, the set of two-tap FIR interpolation filters may comprise up to 32 different two-tap FIR interpolation filters-one for each of the 32 possible values of the fractional part of the projected displacement if. In other examples, different levels of sample accuracy may be used.

In an embodiment, the two-tap interpolation FIR filter may be used for predicting chroma samples. For luma samples, a different interpolation technique may be used. For example, for luma samples a four-tap FIR filter may be used to determine a predicted value of a luma sample. For example, the four tap FIR filter may have coefficients determined based on i_{f}, similar to the two-tap FIR filter. For 1/32 sample accuracy, a set of 32 different four-tap FIR filters may comprise up to 32 different four-tap FIR filters—one for each of the 32 possible values of the fractional part of the projected displacement if. In other examples, different levels of sample accuracy may be used. The set of four-tap FIR filters may be stored in a look-up table (LUT) and referenced based on i_{f}. The value of the predicted sample p[x][y], for vertical prediction modes, may be determined based on the four-tap FIR filter as follows:

$$p [ x ] [ y ] = {\sum }_{𝕝 = 0}^{3} fT [ I ] * ref [ x + ildx + I ] \qquad ( 13 )$$

where ft[i], i=0 . . . 3, are the filter coefficients. The value of the predicted sample p[x][y], for horizontal prediction modes, may be determined based on the four-tap FIR filter as follows:

$$p [ x ] [ y ] = {\sum }_{𝕝 = 0}^{3} fT [ I ] * ref [ x + ildx + I ] . \qquad ( 14 )$$

It should be noted that supplementary reference samples may be constructed for the case where the position [x][y] of a sample in current block 904 to be predicted is projected to a negative x coordinate, which happens with negative vertical prediction angles q. The supplementary reference samples may be constructed by projecting the reference samples in ref₂[y] in the vertical line of reference samples 902 to the horizontal line of reference samples 902 using the negative vertical prediction angle φ. Supplemental reference samples may be similarly for the case where the position [x][y] of a sample in current block 904 to be predicted is projected to a negative y coordinate, which happens with negative horizontal prediction angles φ. The supplementary reference samples may be constructed by projecting the reference samples in ref₁[x] on the horizontal line of reference samples 902 to the vertical line of reference samples 902 using the negative horizontal prediction angle φ.

An encoder may predict the samples of a current block being encoded, such as current block 904, for a plurality of intra prediction modes as explained above. For example, the encoder may predict the samples of the current block for each of the 35 intra prediction modes in HEVC or 67 intra prediction modes in VVC. For each intra prediction mode applied, the encoder may determine a prediction error for the current block based on a difference (e.g., sum of squared differences (SSD), sum of absolute differences (SAD), or sum of absolute transformed differences (SATD)) between the prediction samples determined for the intra prediction mode and the original samples of the current block. The encoder may select one of the intra prediction modes to encode the current block based on the determined prediction errors. For example, the encoder may select an intra prediction mode that results in the smallest prediction error for the current block. In another example, the encoder may select the intra prediction mode to encode the current block based on a rate-distortion measure (e.g., Lagrangian rate-distortion cost) determined using the prediction errors. The encoder may send an indication of the selected intra prediction mode and its corresponding prediction error to a decoder for decoding of the current block.

Similar to an encoder, a decoder may predict the samples of a current block being decoded, such as current block 904, for an intra prediction mode as explained above. For example, the decoder may receive an indication of an angular intra prediction mode from an encoder for a block. The decoder may construct a set of reference samples and perform intra prediction based on the angular intra prediction mode indicated by the encoder for the block in a similar manner as discussed above for the encoder. The decoder would add the predicted values of the samples of the block to a residual of the block to reconstruct the block. In another embodiment, the decoder may not receive an indication of an angular intra prediction mode from an encoder for a block. Instead, the decoder may determine an intra prediction mode through other, decoder-side means.

Although the description above was primarily made with respect to intra prediction modes in HEVC and VVC, it will be understood that the techniques of the present disclosure described above and further below may be applied to other intra prediction modes, including those of other video coding standards like VP8, VP9, AV1, and the like.

As explained above, intra prediction may exploit correlations between spatially neighboring samples in the same picture of a video sequence to perform video compression. Inter prediction is another coding tool that may be used to exploit correlations in the time domain between blocks of samples in different pictures of the video sequence to perform video compression. In general, an object may be seen across multiple pictures of a video sequence. The object may move (e.g., by some translation and/or affine motion) or remain stationary across the multiple pictures. A current block of samples in a current picture being encoded may therefore have a corresponding block of samples in a previously decoded picture that accurately predicts the current block of samples. The corresponding block of samples may be displaced from the current block of samples due to movement of an object, represented in both blocks, across the respective pictures of the blocks. The previously decoded picture may be referred to as a reference picture and the corresponding block of samples in the reference picture may be referred to as a reference block or motion compensated prediction. An encoder may use a block matching technique to estimate the displacement (or motion) and determine the reference block in the reference picture.

Similar to intra prediction, once a prediction for a current block is determined and/or generated using inter prediction, an encoder may determine a difference between the current block and the prediction. The difference may be referred to as a prediction error or residual. The encoder may then store and/or signal in a bitstream the prediction error and other related prediction information for decoding or other forms of consumption. A decoder may decode the current block by predicting the samples of the current block using the prediction information and combining the predicted samples with the prediction error.

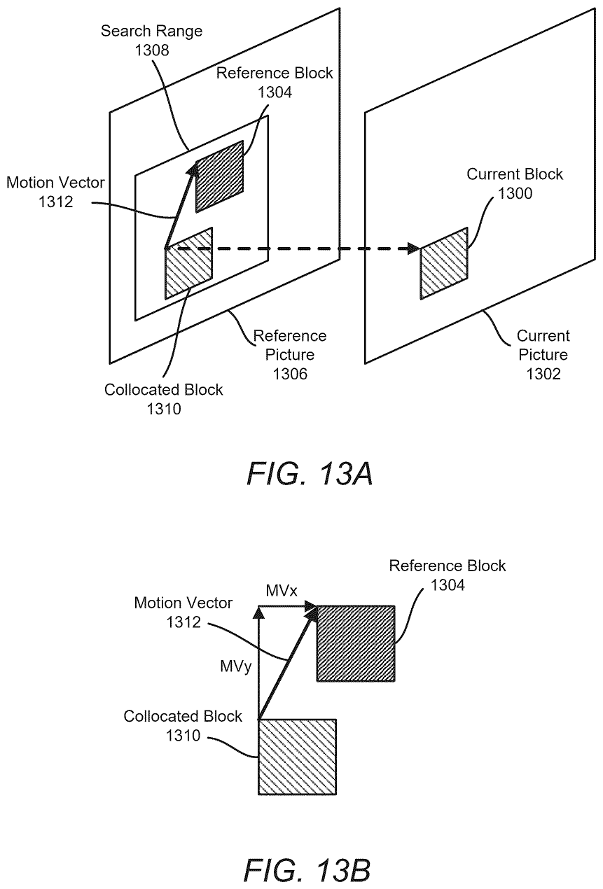

FIG. 13A illustrates an example of inter prediction performed for a current block 1300 in a current picture 1302 being encoded. An encoder, such as encoder 200 in FIG. 2, may perform inter prediction to determine and/or generate a reference block 1304 in a reference picture 1306 to predict current block 1300. Reference pictures, like reference picture 1306, are prior decoded pictures available at the encoder and decoder. Availability of a prior decoded picture may depend on whether the prior decoded picture is available in a decoded picture buffer at the time current block 1300 is being encoded or decoded. The encoder may, for example, search one or more reference pictures for a reference block that is similar to current block 1300. The encoder may determine a “best matching” reference block from the blocks tested during the searching process as reference block 1304. The encoder may determine that reference block 1304 is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), or sum of absolute transformed differences (SATD)) between the prediction samples of reference block 1304 and the original samples of current block 1300.

The encoder may search for reference block 1304 within a search range 1308. Search range 1308 may be positioned around the collocated position (or block) 1310 of current block 1300 in reference picture 1306. In some instances, search range 1308 may at least partially extend outside of reference picture 1306. When extending outside of reference picture 1306, constant boundary extension may be used such that the values of the samples in the row or column of reference picture 1306, immediately adjacent to the portion of search range 1308 extending outside of reference picture 1306, are used for the “sample” locations outside of reference picture 1306. All or a subset of potential positions within search range 1308 may be searched for reference block 1304. The encoder may utilize any one of a number of different search implementations to determine and/or generate reference block 1304. For example, the encoder may determine a set of a candidate search positions based on motion information of neighboring blocks to current block 1300.

One or more reference pictures may be searched by the encoder during inter prediction to determine and/or generate the best matching reference block. The reference pictures searched by the encoder may be included in one or more reference picture lists. For example, in HEVC and VVC, two reference picture lists may be used, a reference picture list 0 and a reference picture list 1. A reference picture list may include one or more pictures. Reference picture 1306 of reference block 1304 may be indicated by a reference index pointing into a reference picture list comprising reference picture 1306.

The displacement between reference block 1304 and current block 1300 may be interpreted as an estimate of the motion between reference block 1304 and current block 1300 across their respective pictures. The displacement may be represented by a motion vector 1312. For example, motion vector 1312 may be indicated by a horizontal component (MVx) and a vertical component (MVy) relative to the position of current block 1300. FIG. 13B illustrates the horizontal component and vertical component of motion vector 1312. A motion vector, such as motion vector 1312, may have fractional or integer resolution. A motion vector with fractional resolution may point between two samples in a reference picture to provide a better estimation of the motion of current block 1300. For example, a motion vector may have ½, ¼, ⅛, 1/16, or 1/32 fractional sample resolution. When a motion vector points to a non-integer sample value in the reference picture, interpolation between samples at integer positions may be used to generate the reference block and its corresponding samples at fractional positions. The interpolation may be performed by a filter with two or more taps.

Once reference block 1304 is determined and/or generated for current block 1300 using inter prediction, the encoder may determine a difference (e.g., a corresponding sample-by-sample difference) between reference block 1304 and current block 1300. The difference may be referred to as a prediction error or residual. The encoder may then store and/or signal in a bitstream the prediction error and the related motion information for decoding or other forms of consumption. The motion information may include motion vector 1312 and a reference index pointing into a reference picture list comprising reference picture 1306. In other instances, the motion information may include an indication of motion vector 1312 and an indication of the reference index pointing into the reference picture list comprising reference picture 1306. A decoder may decode current block 1300 by determining and/or generating reference block 1304, which forms the prediction of current block 1300, using the motion information and combining the prediction with the prediction error.

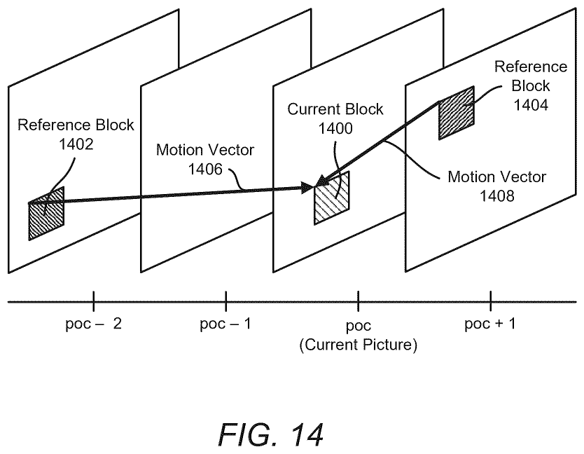

In FIG. 13A, inter prediction is performed using one reference picture 1306 as the source of the prediction for current block 1300. Because the prediction for current block 1300 comes from a single picture, this type of inter prediction is referred to as uni-prediction. FIG. 14 illustrates another type of inter prediction, referred to as bi-prediction, performed for a current block 1400. In bi-prediction, the source of the prediction for a current block 1400 comes from two pictures. Bi-prediction may be useful, for example, where the video sequence comprises fast motion, camera panning or zooming, or scene changes. Bi-prediction may also be useful to capture fade outs of one scene or fade outs from one scene to another, where two pictures are effectively displayed simultaneously with different levels of intensity.

Whether uni-prediction or both uni-prediction and bi-prediction are available for performing inter prediction may depend on a slice type of current block 1400. For P slices, only uni-prediction may be available for performing inter prediction. For B slices, either uni-prediction or bi-prediction may be used. When uni-prediction is performed, an encoder may determine and/or generate a reference block for predicting current block 1400 from reference picture list 0. When bi-prediction is performed, an encoder may determine and/or generate a first reference block for predicting current block 1400 from reference picture list 0 and determine and/or generate a second reference block for predicting current block 1400 from reference picture list 1.

In FIG. 14, inter-prediction is performed using bi-prediction, where two reference blocks 1402 and 1404 are used to predict current block 1400. Reference block 1402 may be in a reference picture of one of reference picture list 0 or 1, and reference block 1404 may be in a reference picture of the other one of reference picture list 0 or 1. As shown in FIG. 14, reference block 1402 is in a picture that precedes the current picture of current block 1400 in terms of picture order count (POC), and reference block 1402 is in a picture that proceeds the current picture of current block 1400 in terms of POC. In other examples, the reference pictures may both precede or proceed the current picture in terms of POC. POC is the order in which pictures are output from, for example, a decoded picture buffer and is the order in which pictures are generally intended to be displayed. However, it should be noted that pictures that are output are not necessarily displayed but may undergo different processing or consumption, such as transcoding. In other examples, the two reference blocks determined and/or generated using bi-prediction may come from the same reference picture. In such an instance, the reference picture may be included in both reference picture list 0 and reference picture list 1.

A configurable weight and offset value may be applied to the one or more inter prediction reference blocks. An encoder may enable the use of weighted prediction using a flag in a picture parameter set (PPS) and signal the weighting and offset parameters in the slice segment header for the current block. Different weight and offset parameters may be signaled for luma and chroma components.

Once reference blocks 1402 and 1404 are determined and/or generated for current block 1400 using inter prediction, the encoder may determine a difference between current block 1400 and each of reference blocks 1402 and 1404. The differences may be referred to as prediction errors or residuals. The encoder may then store and/or signal in a bitstream the prediction errors and their respective related motion information for decoding or other forms of consumption. The motion information for reference block 1402 may include motion vector 1406 and the reference index pointing into the reference picture list comprising the reference picture of reference block 1402. In other instances, the motion information for reference block 1402 may include an indication of motion vector 1406 and an indication of the reference index pointing into the reference picture list comprising the reference picture of reference block 1402. The motion information for reference block 1404 may include motion vector 1408 and the reference index pointing into the reference picture list comprising the reference picture of reference block 1404. In other instances, the motion information for reference block 1404 may include an indication of motion vector 1408 and an indication of the reference index pointing into the reference picture list comprising the reference picture of reference block 1404. A decoder may decode current block 1400 by determining and/or generating reference blocks 1402 and 1404, which together form the prediction of current block 1400, using their respective motion information and combining the predictions with the prediction errors.

In HEVC, VVC, and other video compression schemes, motion information may be predictively coded before being stored or signaled in a bitstream. The motion information for a current block may be predictively coded based on the motion information of neighboring blocks of the current block. In general, the motion information of the neighboring blocks is often correlated with the motion information of the current block because the motion of an object represented in the current block is often the same or similar to the motion of objects in the neighboring blocks. Two of the motion information prediction techniques in HEVC and VVC include advanced motion vector prediction (AMVP) and inter prediction block merging.

An encoder, such as encoder 200 in FIG. 2, may code a motion vector using the AMVP tool as a difference between the motion vector of a current block being coded and a motion vector predictor (MVP). An encoder may select the MVP from a list of candidate MVPs. The candidate MVPs may come from previously decoded motion vectors of neighboring blocks in the current picture of the current block or blocks at or near the collocated position of the current block in other reference pictures. Both the encoder and decoder may generate or determine the list of candidate MVPs.

After the encoder selects an MVP from the list of candidate MVPs, the encoder may signal, in a bitstream, an indication of the selected MVP and a motion vector difference (MVD). The encoder may indicate the selected MVP in the bitstream by an index pointing into the list of candidate MVPs. The MVD may be calculated based on the difference between the motion vector of the current block and the selected MVP. For example, for a motion vector represented by a horizontal component (MVx) and a vertical displacement (Mvy) relative to the position of the current block being coded, the MVD may be represented by two components calculated as follows:

$${MVD}_{x} = {MV}_{x} - {MVP}_{x} \qquad ( 15 )$$

$${MVD}_{y} = {MV}_{y} - {MVP}_{y} \qquad ( 16 )$$

where MVDₓ and MVD_{y} respectively represent the horizontal and vertical components of the MVD, and MVPₓ and MVP_{y} respectively represent the horizontal and vertical components of the MVP. A decoder, such as decoder 300 in FIG. 3, may decode the motion vector by adding the MVD to the MVP indicated in the bitstream. The decoder may then decode the current block by determining and/or generating the reference block, which forms the prediction of the current block, using the decoded motion vector and combining the prediction with the prediction error.

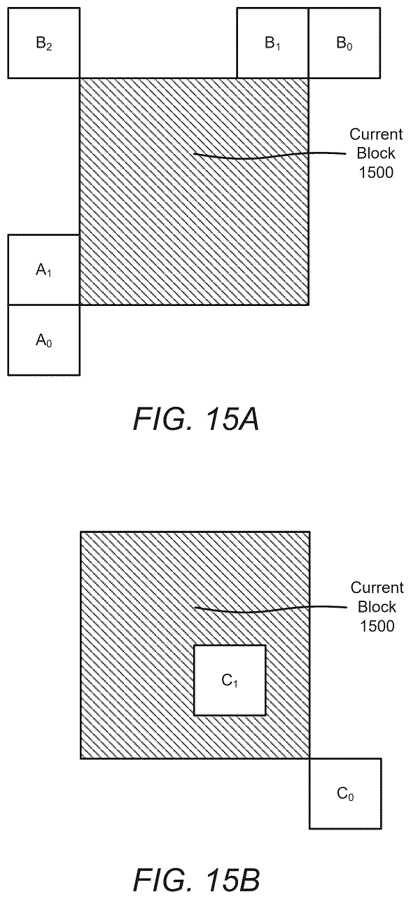

In HEVC and VVC, the list of candidate MVPs for AMVP may comprise two candidates referred to as candidates A and B. Candidates A and B may include up to two spatial candidate MVPs derived from five spatial neighboring blocks of the current block being coded, one temporal candidate MVP derived from two temporal, co-located blocks when both spatial candidate MVPs are not available or are identical, or zero motion vectors when the spatial, temporal, or both candidates are not available. FIG. 15A illustrates the location of the five spatial candidate neighboring blocks relative to a current block 1500 being encoded. The five spatial candidate neighboring blocks are respectively denoted A₀, A₁, B₀, B₁, and B₂. FIG. 15B illustrates the location of the two temporal, co-located blocks relative to current block 1500 being coded. The two temporal, co-located blocks are denoted C₀ and C₁ and are included in a reference picture that is different from the current picture of current block 1500.

An encoder, such as encoder 200 in FIG. 2, may code a motion vector using the inter prediction block merging tool also referred to as merge mode. Using merge mode, the encoder may reuse the same motion information of a neighboring block for inter prediction of a current block. Because the same motion information of a neighboring block is used, no MVD needs to be signaled and the signaling overhead for signaling the motion information of the current block may be small in size. Similar to AMVP, both the encoder and decoder may generate a candidate list of motion information from neighboring blocks of the current block. The encoder may then determine to use (or inherit) the motion information of one neighboring block's motion information in the candidate list for predicting the motion information of the current block being coded. The encoder may signal, in the bitstream, an indication of the determined motion information from the candidate list. For example, the encoder may signal an index pointing into the list of candidate motion information to indicate the determined motion information.

In HEVC and VVC, the list of candidate motion information for merge mode may comprise up to four spatial merge candidates that are derived from the five spatial neighboring blocks used in AMVP as shown in FIG. 15A, one temporal merge candidate derived from two temporal, co-located blocks used in AMVP as shown in FIG. 15B, and additional merge candidates including bi-predictive candidates and zero motion vector candidates.

It should be noted that inter prediction may be performed in other ways and variants than those described above. For example, motion information prediction techniques other than AMVP and merge mode are possible. In addition, although the description above was primarily made with respect to inter prediction modes in HEVC and VVC, it will be understood that the techniques of the present disclosure described above and further below may be applied to other inter prediction modes, including those of other video coding standards like VP8, VP9, AV1, and the like. In addition, history based motion vector prediction (HMVP), combined intra/inter prediction mode (CIIP), and merge mode with motion vector difference (MMVD) as described in VVC may also be performed and are within the scope of the present disclosure.

In inter prediction, a block matching technique may be applied to determine a reference block in a different picture than the current block being encoded. Block matching techniques have also been applied to determine a reference block in the same picture as a current block being encoded. However, it has been determined that for camera-captured videos, a reference block in the same picture as the current block determined using block matching may often not accurately predict the current block. For screen content video this is generally not the case. Screen content video may include, for example, computer generated text, graphics, and animation. Within screen content, there is often repeated patterns (e.g., repeated patterns of text and graphics) within the same picture. Therefore, a block matching technique applied to determine a reference block in the same picture as a current block being encoded may provide efficient compression for screen content video.

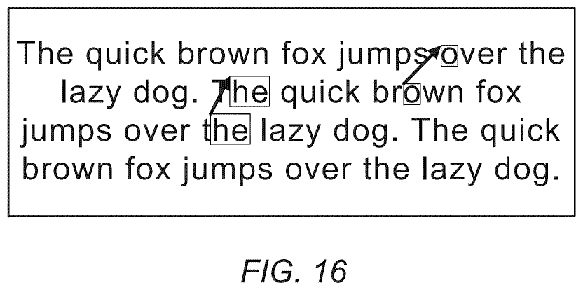

HEVC and VVC both include a prediction technique to exploit the correlation between blocks of samples within the same picture of screen content video. This technique is referred to as intra block copy (IBC) or current picture referencing (CPR). Similar to inter prediction, an encoder may apply a block matching technique to determine a displacement vector (referred to as a block vector (BV)) that indicates the relative displacement from the current block to a reference block (or intra block compensated prediction) that “best matches” the current block. The encoder may determine the best matching reference block from blocks tested during a searching process similar to inter prediction. The encoder may determine that a reference block is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), sum of absolute transformed differences (SATD), or difference determined based on a hash function) between the prediction samples of the reference block and the original samples of the current block. A reference block may correspond to prior decoded blocks of samples of the current picture. The reference block may comprise decoded blocks of samples of the current picture prior to being processed by in-loop filtering operations, like deblocking or SAO filtering. FIG. 16 illustrates an example of IBC applied for screen content. The rectangular portions with arrows beginning at their boundaries are current blocks being encoded and the rectangular portions that the arrows point to are the reference blocks for predicting the current blocks.

Once a reference block is determined and/or generated for a current block using IBC, the encoder may determine a difference (e.g., a corresponding sample-by-sample difference) between the reference block and the current block. The difference may be referred to as a prediction error or residual. The encoder may then store and/or signal in a bitstream the prediction error and the related prediction information for decoding or other forms of consumption. The prediction information may include a BV. In other instances, the prediction information may include an indication of the BV. A decoder, such as decoder 300 in FIG. 3, may decode the current block by determining and/or generating the reference block, which forms the prediction of the current block, using the prediction information and combining the prediction with the prediction error.

In HEVC, VVC, and other video compression schemes, a BV may be predictively coded before being stored or signaled in a bitstream. The BV for a current block may be predictively coded based on the BV of neighboring blocks of the current block. For example, an encoder may predictively code a BV using the merge mode as explained above for inter prediction or a similar technique as AMVP also explained above for inter prediction. The technique similar to AMVP may be referred to as BV prediction and difference coding.

For BV prediction and difference coding, an encoder, such as encoder 200 in FIG. 2, may code a BV as a difference between the BV of a current block being coded and a BV predictor (BVP). An encoder may select the BVP from a list of candidate BVPs. The candidate BVPs may come from previously decoded BVs of neighboring blocks of the current block in the current picture. Both the encoder and decoder may generate or determine the list of candidate BVPs.

After the encoder selects a BVP from the list of candidate BVPs, the encoder may signal, in a bitstream, an indication of the selected BVP and a BV difference (BVD). The encoder may indicate the selected BVP in the bitstream by an index pointing into the list of candidate BVPs. The BVD may be calculated based on the difference between the BV of the current block and the selected BVP. For example, for a BV represented by a horizontal component (BVₓ) and a vertical component (BV_{y}) relative to the position of the current block being coded, the BVD may represented by two components calculated as follows:

$${BVD}_{x} = {BV}_{x} - {BVP}_{x} \qquad ( 17 )$$

$${BVD}_{y} = {BV}_{y} - {BVP}_{y} \qquad ( 18 )$$

where BVDₓ and BVD_{y} respectively represent the horizontal and vertical components of the BVD, and BVPₓ and BVP_{y} respectively represent the horizontal and vertical components of the BVP. A decoder, such as decoder 300 in FIG. 3, may decode the BV by adding the BVD to the BVP indicated in the bitstream. The decoder may then decode the current block by determining and/or generating the reference block, which forms the prediction of the current block, using the decoded BV and combining the prediction with the prediction error.

In HEVC and VVC, the list of candidate BVPs may comprise two candidates referred to as candidates A and B. Candidates A and B may include up to two spatial candidate BVPs derived from five spatial neighboring blocks of the current block being encoded, or one or more of the last two coded BVs when spatial neighboring candidates are not available (e.g., because they are coded in intra or inter mode). The location of the five spatial candidate neighboring blocks relative to a current block being encoded using IBC are the same as those shown in FIG. 15A for inter prediction. The five spatial candidate neighboring blocks are respectively denoted A₀, A₁, B₀, B₁, and B₂.

Transform coefficients occupy a substantial portion of the bitstream from an encoder. This is because portions (e.g., blocks) of each picture are each represented by a matrix of residuals that are then represented by quantized transform coefficients subsequently entropy encoded and transmitted. As explained above, the residuals (e.g., also referred to as prediction error or a residual block) represent differences between values of a block to be encoded (i.e., also referred to as current block to be predicted) and values of a reference block (which corresponds to a reconstructed block used to predict the current block and also referred to as a prediction block) used to predict the current block. Existing technologies have attempted to improve the efficiency of encoding and decoding by taking advantage of arithmetic coders (e.g., Context-Adaptive Binary Arithmetic Codec (CABAC) and the like, but while some of the existing techniques propose to transmit the sign of transform coefficients or prefixes associated with transform coefficients in the regular mode of CABAC, the magnitude values (i.e., absolute levels of transform coefficients) are transmitted in the bypass mode (also known as equiprobable mode) that does not take advantage of the bitrate reduction that is possible in the regular mode.

Embodiments of the present disclosure relate to approaches for entropy encoding and decoding the magnitude, or the magnitude and signs, of transform coefficients using regular mode of arithmetic coders such as CABAC, thereby substantially improving the efficiency by reducing bits needed for coding of pictures. These and other features of the present disclosure are described further below.

An existing technique that is used to reduce the amount of data traffic transmitted from a video encoder to a video decoder focuses on the sign symbols associated with transform coefficients. More specifically, since each block of a picture frame is entropy encoded as a matrix of transform coefficients thus resulting in the encoder having to transmit a bitstream comprising substantially of encoded transform coefficients (e.g., after quantization) to the decoder, and since each transform coefficient has a sign symbol (i.e., positive or negative sign) associated with it, some techniques reduce the amount of data transmitted for communicating sign information by enabling the decoder to predict the signs associated with transform coefficients. Since these techniques enable the decoder to predict the signs for transform coefficients, the encoder can refrain from explicitly encoding a sign with each transform coefficient. It is the residuals, that is the difference between the value to be coded (or predicted) and the reference value (corresponding to an actual reconstructed value of a pixel), that are represented as transform coefficients in the matrix of transform coefficients. Sign prediction for transform coefficients is referred to as residual sign prediction (RSP).

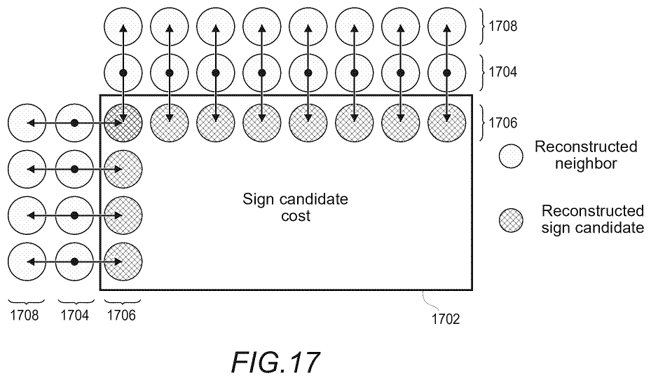

In a first existing approach, residual sign prediction is performed in the spatial domain. Generally, the coefficient sign prediction method includes calculating reconstructed blocks for both negative and positive sign combinations for applicable transform coefficients of residuals as hypotheses and selecting the hypothesis that minimizes a cost function. In one example technique, to derive the “best” sign, the cost function is defined as a discontinuity (e.g., energy discontinuity) measure across a block boundary of the current block (e.g., also referred to as a prediction unit). The cost is determined for all hypotheses, and the hypothesis with the smallest cost (i.e., lowest cost) is selected as a predictor for coefficient signs of the residuals. FIG. 17 shows an example cost calculation across a block boundary of a current block 1702.

In an example, the cost function is defined as a sum of absolute second derivatives in the residual domain for the top row and left column of block 1702 as follows:

$$cost = {\sum }_{x = 0}^{w} \vert ( - {R}_{x , - 1} + 2 {R}_{x , 0} - {P}_{x , 1} ) - {r}_{x , 1} \vert + {\sum }_{y = 0}^{h} \vert ( - {R}_{- 1 , y} + 2 {R}_{0 , y} - {P}_{1 , y} ) - {r}_{1 , y} \vert \qquad ( 19 )$$

where R is reconstructed neighbors (e.g., reconstructed neighboring samples), P is prediction of the current block, and r is the residual hypothesis. The term (−R₋₁+2R₀−P₁) can be calculated only once per block and only residual hypothesis is subtracted. In equation (19), for coordinates (x, y): x=0 and y=0 are x and y coordinates of the left column and the row above, respectively, of samples (e.g., pixels) 1704 immediately neighboring block 1702; x=1 and y=1 are x and y coordinates, respectively, of samples 1706 in the left column and the top row of block 1702; and x=−1 and y=−1 are x and y coordinates, respectively, of samples 1708 in the leftmost column and topmost row from block 1702. P may be determined, in some embodiments, based on reconstructed sample values of neighbors being copied to the current block's sample locations.

The transform coefficients with the largest q_{ldx} value of a sign prediction area (e.g., the top-left 4×4 area) may be selected. q_{ldx} value is the transform coefficient level, in some embodiments, after compensating the impact from the multiple quantizers in DQ (Dependent Quantization). A larger q_{ldx} value may produce a larger de-quantized transform coefficient level. q_{ldx} is derived as follows:

$${q}_{Idx} = ( \vert level \vert ≪ 1 ) - ( state \& 1 ) \qquad ( 20 )$$

where level is the transform coefficient level parsed from the bitstream and state is a variable maintained by the encoder and decoder in DQ.

The sign prediction area may be extended to maximum 32×32. In example embodiments, signs of top-left M×N block are predicted. The value of M and N may be computed as follows:

$$\begin{matrix}M = min ( w , max W ) \\ N = min ( h , max H )\end{matrix} \qquad ( 21 )$$

where w and h are the width and height of the transform block (e.g., such as block 1702). In embodiments, the maximum area for sign prediction is not always set to 32×32. The encoder sets the maximum area (maxW, maxH) based on configuration, sequence class and quantization parameters (QP), and signals the area in the sequence parameter set (SPS).

The maximum number of predicted signs can be kept unchanged for a configurable number of pictures and/or blocks. The sign prediction is also applied to Low-Frequency Non-Separable Transform (LFNST) blocks. And for a LFNST block, a maximum of 4 coefficients in the top-left 4×4 area may be sign-predicted.

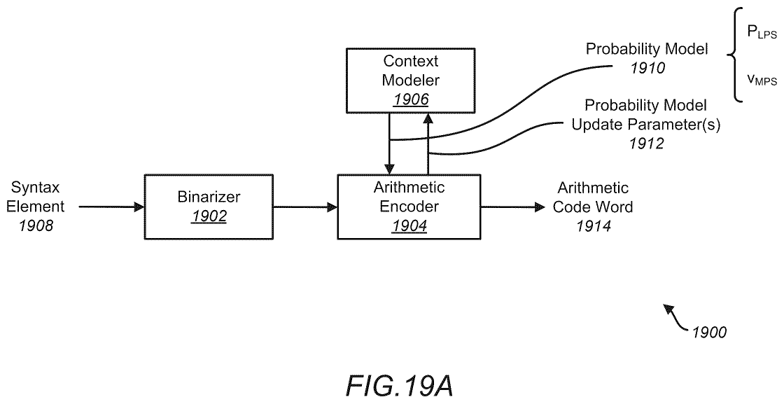

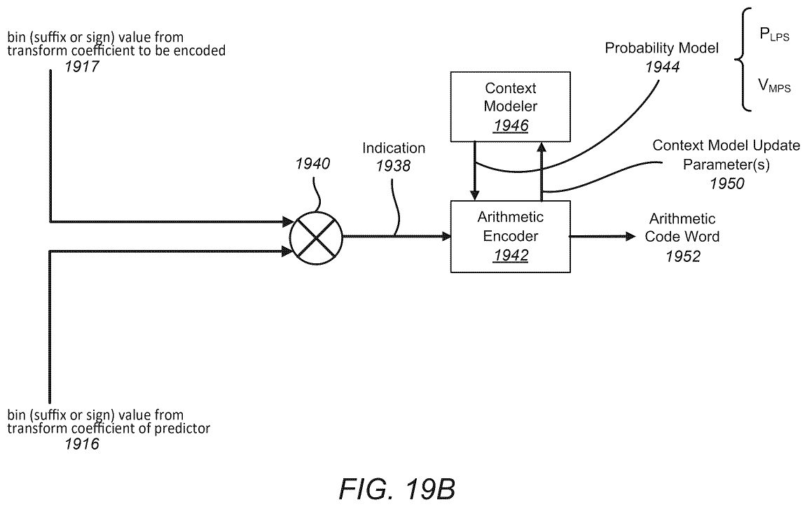

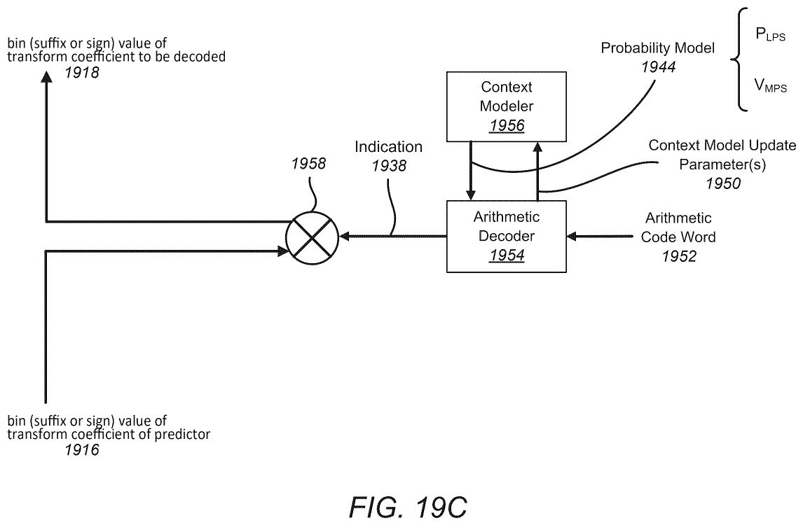

As described below, prediction of the signs enables more efficient entropy encoding in the regular mode of a CABAC encoder, an example of which is described below in relation to FIGS. 19A-C. In sign prediction, in the regular mode of a CABAC encoder a context for a coefficient sign may be selected according to the prediction type (intra/inter-prediction) of a given block, and the magnitude of the associated coefficient (e.g., whether the magnitude value is less than 2 or not).

A disadvantage of the RSP techniques described above as the first approach is that they require a high amount of inverse transform calculations to perform sign estimation. This is because the cost function F (e.g., equation (19) above) for selecting one of the signs sets determined by a hypothesis being checked is calculated by using differences of sample values (e.g., difference of pixel values), and thus is determined in the spatial domain. Despite the presence of fast estimation methods, switching between transform and spatial domains is computationally expensive and is considered as a significant drawback.

Instead of performing inverse transform of the residual signal to obtain reconstructed boundary samples, some techniques have been proposed (see Filippov, A., Rufitskiy, V., Karabutov, A., & Chen, J. (2019). “Residual sign prediction in transform domain for next-generation video coding”. APSIPA Transactions on Signal and Information Processing, 8, E24. doi: 10.1017/ATSIP.2019.6) to perform 1D forward transform over the difference between samples adjacent to the current block (e.g., a subset of samples immediately adjacent and external to the block 1702) and samples of prediction signal of the current block extrapolated to the area of the neighboring pixels in order to perform RSP in the transform domain. According to Parseval's identity, SSD calculated in the transform domain for orthogonal transforms (e.g., such as DCT and DST) gives the same result as SSD calculated in the spatial domain. It is worth noting that this second existing approach to RSP is applicable to a residual signal obtained after directional intra prediction. Additionally, this technique is also applicable to the cases when adjacent blocks are coded using transforms of different types.

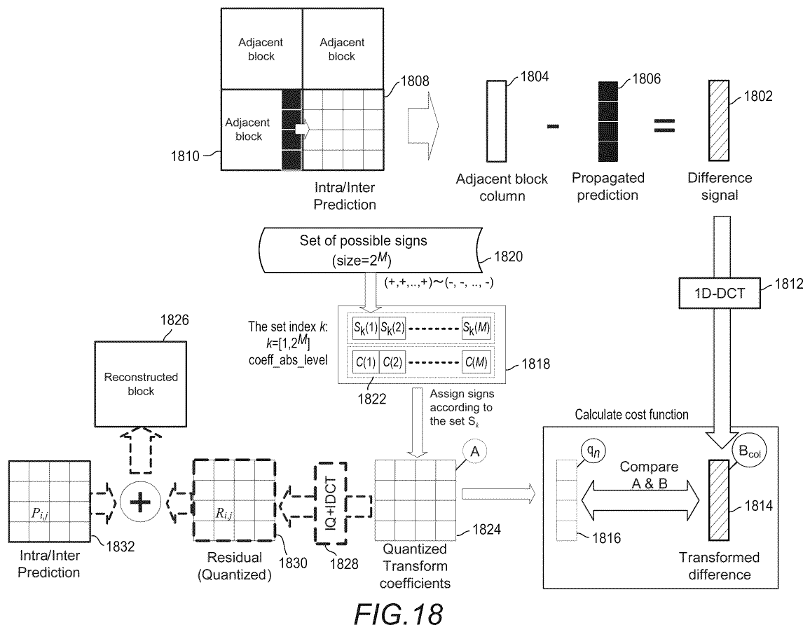

Similarly to RSP in spatial domain described above, in RSP in temporal domain, sign prediction errors are encoded/decoded with a CABAC context model (i.e., regular mode) rather than in bypass mode where each sign value is assumed to be equiprobable. An overview of the hypothesis checking process that can be used for RSP in the transform domain is shown in FIG. 18.

In the example shown in FIG. 18, a difference block 1802 for a set of selected boundary samples of the current block 1808 is calculated as the difference between reconstructed residuals for samples 1804 of an adjacent neighbor block 1810 and predicted values for boundary samples 1806 of the current block 1808. The difference block 1802 of samples are then 1D-transformed 1812 (e.g., DCT) to generate transformed differences 1814 corresponding to transform coefficients (i.e., also referred to as transform coefficients difference).

The transformed differences 1814 are compared to each hypothesis (generated as transform coefficients 1816) of a plurality of hypotheses. The plurality of hypotheses 1818 may be generated by assigning the set of possible signs 1820 to the set of transform coefficients 1822 in block of transform coefficients 1824. Block of transform coefficients 1824 is the current block to be decoded represented in the frequency/transform domain as quantized transform coefficients. In order to generate the set of hypotheses 1818, the set of signs 1820 are assigned in each possible combination to the set of transform coefficients 1816 or to the block of transform coefficients 1824 from which the set of transform coefficients 1816 is obtained for comparing with transformed differences 1814. In the illustrated example, coefficients of transformed differences 1814 and transform coefficients 1816 are based on the left most columns in the current block 1808 and the block of transform coefficients 1824 (also referred as prediction block), respectively. Since both coefficients of transformed differences 1814 and transform coefficients 1816 are in the transform domain, no inverse transforms are needed for the comparison. It should be noted that since the block of received transform coefficients 1824 are the result of samples being subjected to a 2D transform operation performed at encoding, a 1D transform is performed on the left column to obtain the sign-hypothesized transform coefficients 1816 to be compared to the set of coefficients in the transformed differences 1814.

It will be noted that an inverse quantization and inverse transform 1828 is performed on the current block of received transform coefficients 1824 to obtain residuals 1830 in the spatial domain that is then combined with the predictions 1832 derive the reconstructed block 1826.

For the sake of simplicity, only the column of the adjacent block is shown in FIG. 18. It should be understood that the top row could also be used for hypothesis checking, for example, as illustrated in FIG. 17 where it was shown that the left-most column and the top-most row can both be used in the cost calculation. The basic idea underlying the concept of transform domain residual sign prediction (TDRSP) consists of estimating energy of discontinuity on the block boundary in transform domain without inverse transform of residual signal during hypothesis checking. For this purpose, the impact of prediction and residual signals on the energy of the discontinuity is estimated separately. Note that estimating discontinuity using the L1 norm (sum of absolute differences) in the transform domain will not be applicable since linear transforms preserve energy of the signals but not their absolute values. Hence, rewriting cost estimation function F described above in regard to RSP in spatial domain to use L2-norm, i.e., a sum of squared differences (SSD), gives:

$$F = {\sum }_{n = 0}^{N - 1} {( [ 2 {X}_{n , - 1} - {X}_{n , - 2} - {Y}_{n , 0} ] )}^{2} + {\sum }_{m = 0}^{M - 1} {( [ 2 {Z}_{- 1 , m} - {Z}_{- 2 , m} - {Y}_{0 , m} ] )}^{2} , \qquad ( 22 )$$

where N and M are height and width of the block, respectively. Samples of reconstructed block can be represented as a decomposition of prediction and residual components:

$${Y}_{i , j} = {P}_{i , j} + {R}_{i , j} , \qquad ( 23 )$$

where P_{i,j} are predicted samples, and R_{i,j} are residuals in spatial domain. After substitution and rearrangement, residual signal in spatial domain can be expressed explicitly:

$$F = {\sum }_{n = 0}^{N - 1} {( [ 2 {X}_{n , - 1} - {X}_{n , - 2} - {P}_{n , 0} ] - {R}_{n , 0} )}^{2} + {\sum }_{m = 0}^{M - 1} {( [ 2 {Z}_{- 1 , m} - {X}_{- 2 , m} - {P}_{0 , m} ] - {R}_{0 , m} )}^{2} \qquad ( 24 )$$

since the prediction component and neighboring samples are invariant to residual sign manipulation, it is reasonable to use the following denotations:

$${T}_{n} = [ 2 {X}_{n , - 1} - {X}_{n , - 2} - {P}_{n , 0} ] , \qquad ( 25 )$$

$${V}_{m} = [ 2 {Z}_{- 1 , m} - {Z}_{- 2 , m} - {P}_{0 , m} ] ,$$

$${Q}_{n} = {R}_{n , 0} , and {O}_{m} = {R}_{0 , m} .$$

Applying Parseval's identity, the cost function could be estimated in transform domain:

$$F = {\sum }_{n = 0}^{N - 1} {( {T}_{n} - {Q}_{n} )}^{2} + {\sum }_{m = 0}^{M - 1} {( {V}_{m} - {O}_{m} )}^{2} ≡ {\sum }_{n = 0}^{N - 1} {( {t}_{n} - {q}_{n} )}^{2} + {\sum }_{m = 0}^{M - 1} {( {v}_{m} - {o}_{m} )}^{2} \qquad ( 26 )$$

where tₙ=Trans1D(Tₙ), qₙ=Trans1D(Qₙ), vₙ=Trans1D(Vₙ), oₙ=Trans1D(Oₙ), Trans1D( ) is a 1D orthogonal transform.

Thereafter, the cost function can be calculated, and, therefore, signs of quantized transform coefficients in the transform domain can be predicted. Moreover, it may not be required to completely recalculate the cost function value per sign combination. It is enough to just re-estimate its residual components, i.e., oₘ and qₙ, per sign combination.

RSP techniques rely on the properties of the transform that is applied to the residual signal. If performed in spatial domain, the hypothesis check requires performing inverse transforms that can be computationally intensive in case a secondary transform is used. Introduction of non-separable transforms such as Non-Separable Secondary Transform (NSST) and Low-Frequency Non-Separable Transform (LFNST) that do not preserve Euclidean norm in transform domain makes difficult the use of time domain RSP. The latter technique utilizes the properties of Parseval's identity that does not hold for NSST. Hence, a preferable way to harmonize an RSP technique with secondary transforms is to skip RSP in blocks to which secondary transforms are applied.

Enhanced multiple transform (EMT) is a less RSP-abusing technique, since a selected transform is applied to a residual signal only once (just as in conventional case), and the transform is still orthogonal and separable. However, in the case of time domain RSP, the difference in transform type in horizontal and vertical directions require special handling when performing forward 1D-transform of the neighboring area. Specifically, the transform type should be the same for the adjacent column of the neighbor block and the vertical transform or the residual signal, as well as for the adjacent row of the upper neighbor block and horizontal transform of the residual signal. Preferably, EMT signaling should precede transform coefficients coding in the parsing process.

In video coding technologies such as HEVC and VVC, CABAC is employed for entropy coding of low-level syntax elements. Non-binary syntax elements are mapped to binary codewords. The bijective mapping between the syntax elements (e.g., values of the syntax elements which may be non-binary) and symbols and/or codewords, for which typically structured codes are used, is referred to as binarization. The binary symbols, also called bins, of both binary syntax elements and codewords for non-binary data are coded using arithmetic coding such as binary arithmetic coding. The core coding engine supports two operating modes: a regular mode, in which the bins are coded with adaptive probability models, and a less complex bypass mode that uses fixed probabilities of ½. FIGS. 19A-B schematically illustrate a CABAC encoder, and FIG. 19C shows a corresponding CABAC decoder. The adaptive probability models are also called contexts and the assignment of probability models to individual bins is referred to as context modeling.

FIG. 19A illustrates an example implementation of a context-based adaptive binary arithmetic coding (CABAC) encoder 1900 in accordance with some embodiments of the present disclosure. CABAC encoder 1900 may be implemented in a video encoder, such as video encoder 200 in FIG. 2, for entropy encoding syntax elements of a video sequence. As illustrated in FIG. 19A, CABAC encoder 1900 includes a binarizer 1902, an arithmetic encoder 1904, and a context modeler 1906. Binarization in the binarizer 1902 maps the syntax elements to binary symbols (bins). Context modeling by the context modeler 1906 estimates the probability of each non-bypassed (i.e., regular coded) bin based on some specific context. Finally, binary arithmetic coding in the arithmetic encoder 1904 compresses the bins to bits according to the estimated probability.

CABAC encoder 1900 may receive a syntax element 1908 for arithmetic encoding. Syntax elements, such as syntax element 1908, may be generated at a video encoder and may describe how a video signal may be reconstructed at a video decoder. For a block, such as a coding unit (CU), the syntax elements may comprise transform coefficients. In some embodiments, each transform coefficient is represented by a sign component, prefix component and suffix component.

Binarizer 1902 may first map the value of syntax element 1908 to a sequence of binary symbols (also referred to as bins). Binarizer 1902 may define a unique mapping of values of syntax element 1908 to sequences of binary symbols. Binarization of syntax elements may help to improve probability modeling and implementation of arithmetic encoding. Binarizer 1902 may implement one or more binarization processes, such as unary, truncated unary, k-th order truncated Rice, k-th order exponential-Golomb (EGk), fixed-length, or some combination of two or more of these binarization processes. Binarizer 1902 may select a binarization process based on a type of syntax element 1908 and/or one or more syntax elements processed by CABAC encoder 1900 before syntax element 1908. Based on syntax element 1908 already being represented by a sequence of one or more binary symbols, binarizer 1902 may not process syntax element 1908. In another example, binarizer 1902 may not be used and syntax element 1908 represented by a sequence of one or more non-binary symbols may be directly encoded by CABAC encoder 1900.

After binarizer 1902 optionally maps the value of syntax element 1908 to a sequence of binary symbols, one or more of the binary symbols may be processed by arithmetic encoder 1904. Arithmetic encoder 1904 may process each of the one or more binary symbols in one of at least two modes: regular arithmetic encoding mode or bypass arithmetic encoding mode.

Arithmetic encoder 1904 may process binary symbols that do not have a uniform (or approximately uniform) probability distribution in regular arithmetic encoding mode (e.g., binary symbols that do not have a probability distribution of 0.5 for each of their two possible values). In regular arithmetic encoding mode, arithmetic encoder 1904 may perform arithmetic encoding as described above. For example, arithmetic encoder 1904 may subdivide a current coding interval into m disjoint subintervals. Each of the m disjoint subintervals may have a width proportional to the probability of the binary symbol having a different one of the values in an m-ary source alphabet. In the case of a binary symbol, m is equal to two and the current coding interval may be subdivided into two disjoint intervals that each have a width proportional to the probability of a different one of the two possible values {0, 1} for the binary symbol being encoded. The probabilities of the two possible values for the binary symbol may be indicated by a probability model 1910 for the binary symbol. Arithmetic encoder 1904 may then encode the binary symbol by choosing the subinterval corresponding to the actual value of the binary symbol as the new coding interval for the next binary symbol to be encoded.

Arithmetic encoder 1904 may receive probability model 1910 from context modeler 1906. Context modeler 1906 may determine probability model 1910 for the binary symbol by a fixed selection (e.g., based on a position of the binary symbol in the sequence of binary symbols representing syntax element 1908) or by an adaptive selection from among two or more probability models (e.g., based on information related to the binary symbol). As shown in FIG. 19A, probability model 1910 may comprise two parameters: the probability P_{LPS} of the least probable symbol (LPS) and the value v_{MPS} of the most probable symbol (MPS). In other examples, probability model 1910 may comprise the probability P_{MPS} of the MPS in addition or alternatively to the probability P_{LPS} of the LPS. Similarly, in other examples, probability model 1910 may comprise the value v_{LPS} of the LPS in addition or alternatively to the value v_{MPS} of the MPS. After arithmetic encoder 1904 encodes the binary symbol, arithmetic encoder 1904 may provide one or more probability model update parameters 1912 to context modeler 1906. Context modeler 1906 may adapt probability model 1910 based on the one or more probability model update parameters 1912. For example, the one or more probability model update parameters 1912 may comprise the actual coded value of the binary symbol. Context modeler 1906 may update probability model 1910 by increasing P_{LPS} if the actual coded value of the binary symbol is not equal to v_{MPS} and by decreasing P_{LPS} otherwise.

Arithmetic encoder 1904 may process binary symbols that have (or are assumed to have) a uniform (or approximately uniform) probability distribution in bypass arithmetic encoding mode. Because binary symbols processed by arithmetic encoder 1904 in bypass arithmetic encoding mode have (or are assumed to have) a uniform (or approximately uniform) probability distribution, arithmetic encoder 1904 may bypass probability model determination and adaptation performed in regular arithmetic encoding mode when encoding these binary symbols to speed up the encoding process. In addition, subdivision of the current coding interval may be simplified given the uniform (or assumed uniform) probability distribution. For example, the current coding interval may be partitioned into two disjoint subintervals of equal width, which may be realized using a simple implementation that may further speed up the encoding process. Arithmetic encoder 1904 encodes a binary symbol by choosing the subinterval corresponding to the value of the binary symbol as the new coding interval for the next binary symbol to be encoded. The resulting increase in encoding speed for binary symbols encoded by arithmetic encoder 1904 in bypass arithmetic encoding mode is often important because CABAC encoding may have throughput limitations.

After processing a number of binary symbols (e.g., corresponding to one or more syntax elements), arithmetic encoder 1904 may determine a value in the range of the final coding interval as an arithmetic code word 1914 for the binary symbols. Arithmetic encoder 1904 may then output arithmetic code word 1914. For example, arithmetic encoder 1904 may output arithmetic code word 1914 to a bitstream that may subsequently be received and processed by a video decoder.

Note that both the binarization and the context modeling used have a significant impact on coding efficiency of a CABAC coder. The required encoder and decoder complexities primarily increase with the number of context-coded bins (i.e., bins coded in regular mode). But they are also affected by other aspects such as the degree of dependencies between successive bins, the complexity of the context modeling used, or the frequency with which a switching between the regular and bypass modes of the arithmetic coding engine occurs.

The entropy coding of quantization indexes for transform blocks is commonly referred to as transform coefficient coding. Since, at typical video bit rates, transform coefficient levels consume a major part of the total bit rate, it is important to find a reasonable trade-off between coding efficiency and implementation complexity. The basic concept of the transform coefficient coding in VVC is similar to the coefficient coding specified in HEVC: a coded block flag (CBF) indicates whether a transform block includes any nonzero levels; for transform blocks with CBF equal to 1 (i.e., block includes non-zero levels), the x and y coordinate of the last nonzero level in forward scan order is transmitted; Starting from the indicated last non-zero position, the levels are transmitted in reverse scan order, organized into so-called coefficient groups (CGs). The bins for a CG are coded in multiple passes by the CABAC encoder, where all bypass-coded bins can be grouped together in order to enable efficient implementations.

Since VVC supports a larger range of transform sizes than HEVC, some aspects of the transform coefficient coding are generalized. In contrast to HEVC, the scan order does not depend on the intra prediction mode as such a mode-dependent scan was found to provide only negligible improvements and would unnecessarily complicate the design. Moreover, in VVC, the context modeling for the bins representing levels is independent of the block size; there are no exceptions for certain block shapes. But instead, the context dependency restrictions found in HEVC are relaxed and local statistical dependencies between levels are utilized for increasing coding efficiency. For enabling the exploitation of certain trellis coded quantization (TCQ) properties, the binarization for levels includes a parity bin and all context-coded bins of a CG are coded in a single pass. VVC uses a transform block-based restriction on the number of context-coded bins to keep a similar worst-case complexity as HEVC.

The CBF is coded in the regular mode of the coding engine. In total, 9 contexts are used (4 for luma, 2 for Cb, and 3 for Cr). One context per component is reserved for blocks coded in block-based delta pulse code modulation (BDPCM) mode (a special variant of the transform skip mode). For luma, two contexts are used only for transform blocks coded in the intra sub-partitioning mode; here, the chosen context depends on the CBF of the preceding luma transform block inside the same coding unit. In order to exploit statistical dependencies between the CBFs of the chroma components, the context for Cr blocks not coded in BDPCM mode is selected depending on the CBF of the co-located Cb block.

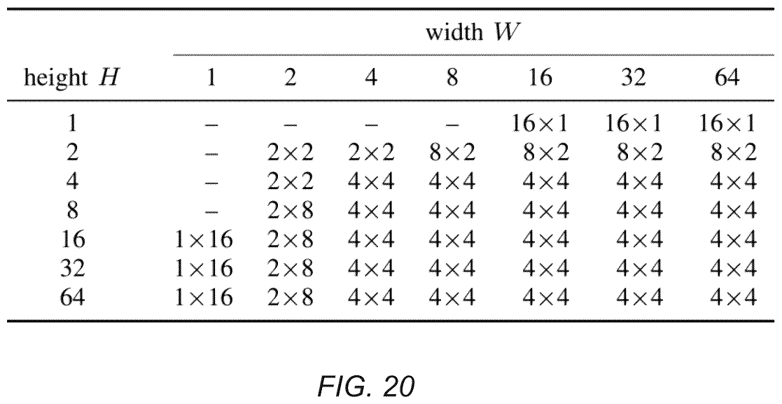

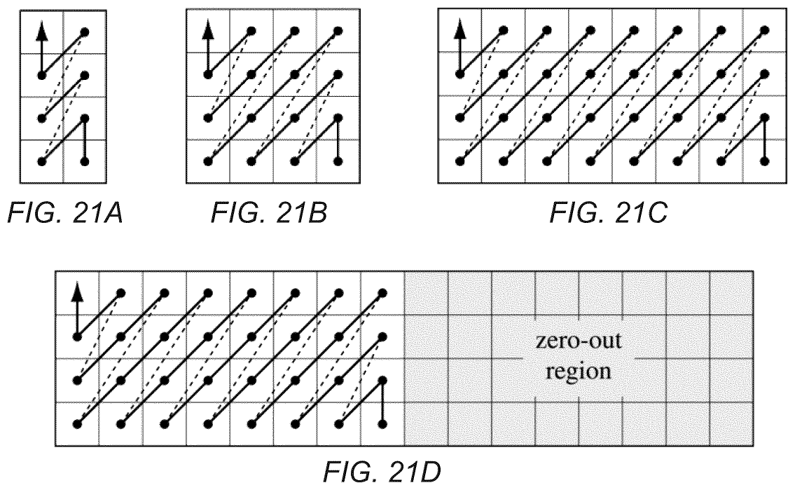

The transform coefficient levels {q} of a W×H transform block are arranged in a W×H matrix. For enabling a harmonized processing across all blocks but also for increasing coding efficiency for transform blocks, in which the signal energy is concentrated into transform coefficients that correspond to low horizontal or low vertical frequencies, transform blocks are partitioned into CGs. The levels for each CG are coded in a unified manner using multiple scan passes. Since VVC also supports block sizes with widths and heights less than 4, the shape of CGs depends on the transform block size as shown in the table of FIG. 20 of CG sizes for W×H transform blocks. In an example embodiment, for transform blocks with at least 16 coefficients, the CGs always include 16 levels; for smaller blocks, CGs of 2×2 levels are used. The coding order of CGs is given by the reverse diagonal scan illustrated in FIGS. 21A-21C. Independent of the CG size, the CG diagonals are processed from the bottom right to the top left of a transform block, where each diagonal is scanned in down left direction. The coding order of levels inside CGs is specified by the same reverse diagonal scan. FIGS. 21A-21D illustrate the reverse diagonal scan: coding order of CGs in FIG. 21A is 8×16 blocks, in FIG. 21B is 16×16 blocks, in FIG. 21C is 32×16 blocks, and in FIG. 21D is 64×16 blocks. The scan shown in FIG. 21B also illustrates the coding order of levels in 4×4 CGs.

For limiting the worst-case decoder complexity for large transform sizes, transform coefficients at high-frequency locations can be forced to be equal to zero. Nonzero quantization indexes can only be present in a min(W,Wn)×min(H,Hn) region at the top-left of a transform block, where Wn×Hn denotes the size of the non-zero-out area that can be inferred at the decoder side. CGs outside this region are not coded and thus excluded from the scan as illustrated in FIG. 21D. In many cases, Wn×Hn is equal to 32×32, which is in some embodiments the maximum supported size for the non-zero-out area. Although VVC specifies smaller non-zero-out areas for transforms other than the DCT-II, this does, in general, not impact the transform coefficient coding, since the syntax elements specifying the transform used are coded after the levels and they are conditioned on the presence of nonzero levels in certain regions. The only exception are luma blocks, with max(W,H)≤32, that are coded in a special subblock transform mode. If non-DCT-II transforms are enabled (on a sequence level), in some embodiments these blocks are always coded using non-DCT-II transforms and, hence, the size of the non-zero-out area is inferred to be equal to 16×16.

Similar as in HEVC, the explicit coding of zero quantization indexes for coefficients related to high-frequency components is eliminated by transmitting the position of the last nonzero level in forward scan order (which is the first nonzero level in coding order). This does not only increase coding efficiency, but also reduces the number of context-coded bins.

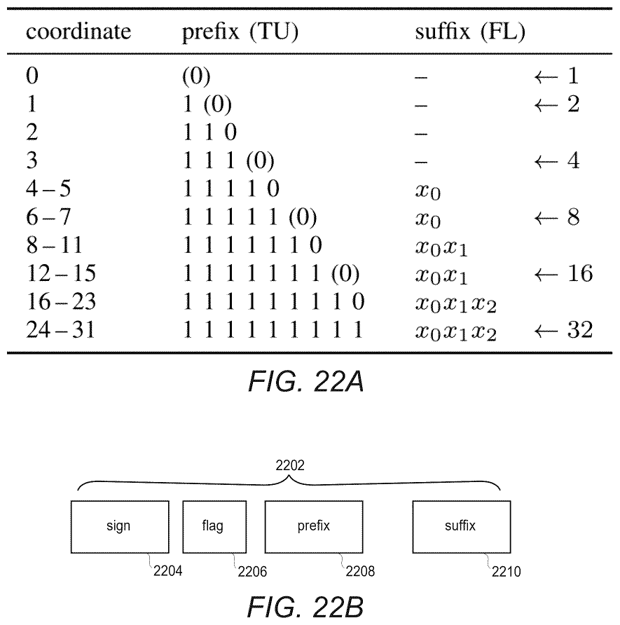

The x and y coordinates corresponding to the column and row number, respectively, in the matrix of coefficient levels are transmitted independently of each other. As shown in the table of FIG. 22A, each component is represented by a combination of a prefix codeword and a (possibly empty) suffix codeword. For example, each transform coefficient 2202 may be represented as syntax elements including, a sign component 2204, a flag component 2206, the prefix component 2208, and the suffix component 2210, as shown in FIG. 22B. The prefix part specifies an interval of values. It is binarized using truncated unary (TU) binarization and the bins are coded in regular mode. The prefix part indicating the last interval of the non-zero-out region of a transform block is truncated. That means, the zero bins in parenthesis shown in FIG. 22A are not coded if min(W,Wn), for the x coordinate, or min(H,Hn), for the y coordinate, is equal to the number in the last table column. In particular, the coding of a coordinate is completely skipped if the corresponding block width or height is equal to 1. The suffix part represents the offset inside the interval indicated by the prefix part. It is binarized using fixed length (FL) binarization. Only x and y coordinates with values greater than 3 have a suffix part. In conventional techniques, the suffix part is coded in the bypass mode of the CABAC encoder.

At the decoder side, the values of the x and y coordinates of the last significant level are derived as follows. Let vₚᵣₑ be the number of bins equal to 1 in the prefix codeword. Then, the number n_{suf} of suffix bins to be decoded is derived by:

$${n}_{suf} = max ( 0 , ⌊ {v}_{pre} / 2 ⌋ - 1 ) . \qquad ( 27 )$$

With v_{suf} being the value specified by the suffix codeword (in binary representation), the decoded coordinate value last is calculated according to

$$last = \{ \begin{matrix}{2}^{{n}_{suf}} \cdot ( 2 + ( {v}_{pre} \& 1 ) ) + {v}_{suf} , & {n}_{suf} > 0 \\ {v}_{pre} , & otherwise\end{matrix} . \qquad ( 28 )$$

The prefix part for the x coordinate is signaled first followed by that for the y coordinate. For grouping bypass-coded bins, the suffix parts are coded after the prefix codewords. The prefix bins of the x and y coordinates are coded using separate sets of context models. The table in FIG. 22A lists the context offsets that indicate the probability model used inside a set. The model chosen may depend on whether a luma or chroma block is coded, the width or height of the transform block, and the bin number inside the prefix codeword. Note that for large transform blocks, where zero-out is present, the transform dimension (and not the dimension of the non-zero-out region) is used to derive the context offset. In total, 46 contexts (40 for luma and 6 for chroma) are used for coding the last coefficient position.

Starting with the CG containing the last nonzero level (as indicated by the x and y coordinates), the CGs are transmitted in coding order (given by the reverse diagonal scan). The first syntax element coded for a CG is the sb_coded_flag. If this flag is equal to 0, it indicates that the CG contains only zero levels. For the first CG (which contains the last nonzero level) and the last CG (which contains the DC level), this flag is not coded, but inferred to be equal to 1. The sb_coded_flag is coded in regular mode in the CABAC encoder. The chosen context depends on whether the CG to the right or the CG below contain any nonzero levels, where separate context sets are specified for luma and chroma. In total, 4 contexts (2 for luma and 2 for chroma) are used. For CGs with sb_coded_flag equal to 1, the level values are coded as described below.

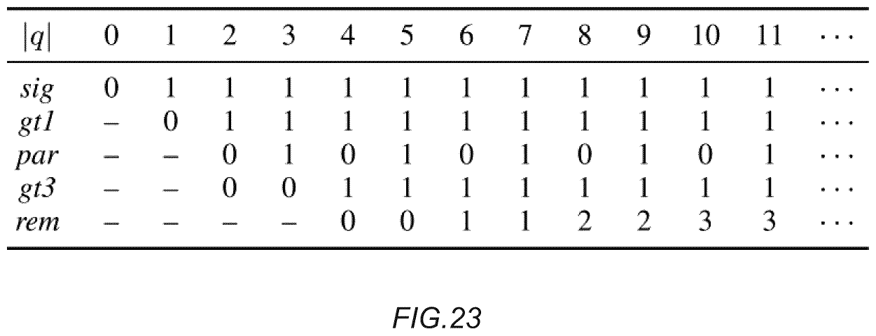

The binarization of coefficient levels and the coding order of bins are chosen to support an efficient entropy coding for both TCQ and conventional quantization. Due to the different structures of the two scalar quantizers Q0 and Q1 used in TCQ, the probability that a level is equal to 0 highly depends on the quantizer used. For exploiting this effect in context modeling and, at the same time, grouping the context- and bypass-coded bins, the binarization includes a dedicated parity flag that is used for determining the TCQ state during entropy coding. By additionally taking into account the number of context-coded bins required for achieving a good coding efficiency as well as the dependencies between successive bins, the binarization of absolute level values shown in the table of FIG. 23 can be used in VVC. The absolute values |q| of the quantization indexes are mapped to the bins sig (significance), gt1 (greater than 1), par (parity), gt3 (greater than 3), and the non-binary remainder rem.

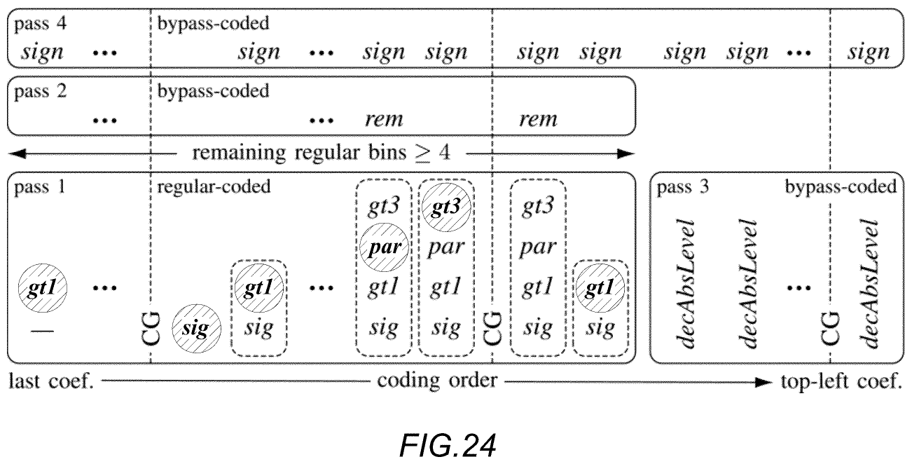

The syntax elements for a CG are coded in multiple passes over the scan positions. Unlike HEVC, where a single syntax element per coefficient is coded per scan pass, VVC may code up to 4 syntax elements per coefficient in a single pass. In the first pass, the context-coded bins sig, gt1, par, and gt3 are coded in an interleaved manner (i.e., all bins for a scan position are coded before proceeding to the next scan position). Note that the parity bin driving the TCQ state machine is included in the first pass for enabling an efficient coding of the sig bin for the TCQ case. For scan positions for which the sig bin can be inferred to be equal to 1 (e.g., for the last significant position), it is not signaled. The presence of the gt1, par, and gt3 bins is controlled as specified in FIG. 24. The non-binary remainders rem are coded in a second scan pass. They are binarized using similar parametric codes as in HEVC and the resulting bins are coded in bypass mode.

In order to increase the worst-case throughput, the number of context-coded bins that can be coded in the first pass is restricted. For allowing a suitable distribution of context-coded bins across CGs, the limit is specified on a transform block basis. With N being the number of transform coefficients in the non-zero-out region of a transform block, the maximum allowed number of context-coded bins is set to 1.75×N. This would correspond to 28 bins per CG if the bin budget was distributed equally among CGs, which is only slightly higher than the limit specified in HEVC (25 bins). The limit on context-coded bins may be enforced as follows. If, at the start of a scan position, the total number of already coded sig, gt1, par, and gt3 bins for the transform block exceeds 1.75×N−4, i.e., less than 4 bins are remaining in the budget, the first coding pass is terminated. In that case, the absolute values |q| for the remaining scan positions are coded in a third scan pass. They are represented by syntax elements decAbsLevel, which may be completely coded in bypass mode.

In the fourth and last pass, the signs for all nonzero levels of a CG are coded in bypass mode. If sign data hiding (SDH) is enabled and the difference between the scan indexes of the last and first nonzero level inside the CG is greater than 3, the sign for the last nonzero level is not signaled. FIG. 24 illustrates the organization of level data into the different scan passes. The arrangement of the scan passes (shaded bins have zero values) can be seen in FIG. 24. Before the limit for the number of regular-coded bins is reached, the absolute levels for a CG are coded in passes 1 and 2. After reaching the limit, the remaining absolute values are coded only in pass 3. The signs are coded in the last pass.

In order to efficiently utilize conditional statistics for arithmetic coding, VVC uses a rather large set of context models for coding the bins sig, gt1, par, and gt3. Beside the TCQ state, the context modeling also exploits statistical dependencies between spatially neighboring quantization indexes.

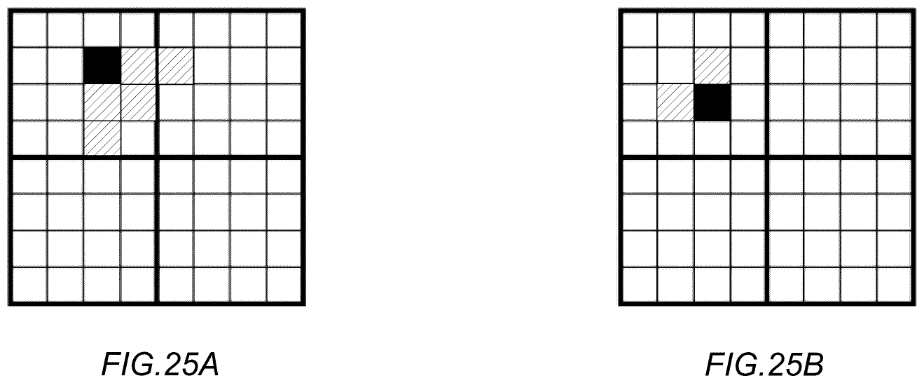

The context for the sig bin depends on the associated TCQ state sₖ, the diagonal position d=x+y of the coefficient inside the transform block, and the sum of partially reconstructed absolute levels q* inside the local template T (shaded area) illustrated in FIG. 25A. FIGS. 25A-B illustrate example local templates T. The partially reconstructed absolute levels are given by already coded bins for neighboring scan positions and can be calculated according to

$${q}^{*} = sig + gt 1 + par + 2 \cdot gt 3. \qquad ( 29 )$$

For luma blocks, the context index

$${c}_{lum}^{sig}$$

indicating the adaptive probability model used is derived according to

$${c}_{chr}^{sig} = 12 \cdot max ( 0 , {s}_{k} - 1 ) + {f}_{sig} ( T ) + \{ \begin{matrix}8 , & d < 2 \\ 4 , & 2 \leq d \\ 0 , & d \geq 5\end{matrix} \qquad ( 30 )$$

$$with$$

$${f}_{▯▯▯} ( T ) = min ( 3 , ( 1 + {\sum }_{T} {q}^{*} ) ≫ 1 ) \qquad ( 31 )$$

being a function of the partially reconstructed levels q* inside the local template T. For chroma blocks, only two classes of diagonal positions (d<2 and d≥2) are used. The context index

$${c}_{chr}^{sig}$$

is derived by:

$${c}_{chr}^{sig} = 8 \cdot max ( 0 , {s}_{k} - 1 ) + {f}_{sig} ( T ) + \{ \begin{matrix}4 , & d < 2 , \\ 0 , & d \geq 2\end{matrix} . \qquad ( 32 )$$

When TCQ is not enabled, the value of the TCQ state sₖ is set equal to 0. In total, in some embodiments, 60 context models are used for coding the sig bin (36 for luma and 24 for chroma).

The probability models chosen for gt1, par, and gt3 do not depend on the TCQ state, as it was found to provide only a very minor benefit. A single shared context offset is computed to select the probability model for these syntax elements. They are chosen based on the diagonal position d of the coefficient (4 classes for luma and 2 for chroma) and the sum of the values max(0, q*−1) inside the local template T. With

$$f ( T ) = min ( 4 , {\sum }_{▯} max ( 0 , {q}^{*} - 1 ) ) \qquad ( 33 )$$

being another function of the partially reconstructed levels q* inside the local template T, the context indexes cₗᵤₘ and c_{chr} for luma and chroma blocks, respectively, are given by:

$${c}_{lum} = f ( T ) + \{ \begin{matrix}1 , & d \geq 10 , \\ 6 , & 3 \leq d < 10 , \\ 11 , & 0 < d < 3 , \\ 16 , & d = 0\end{matrix} , \qquad ( 34 )$$

$${c}_{chr} = f ( T ) + \{ \begin{matrix}1 , & d > 0 \\ 6 , & d = 0\end{matrix} .$$

In addition, for the last coefficient position a separate context (given by cₗᵤₘ=0 and c_{chr}=0) is used. For each of the gt1, par, and gt3 bins, 32 probability models (21 for luma and 11 for chroma) are used in some embodiments.

The syntax elements rem coded in the second pass represent remainders for absolute levels. They are only transmitted for a scan position if the associated gt3 bin is equal to 1. With q* being a partially reconstructed level according to (29), the absolute value |q| of the level is given by:

$$\vert q \vert = {q}^{*} + 2 \cdot rem . \qquad ( 35 )$$

The remainders rem and the syntax elements decAbsLevel, which represent absolute levels coded in the third pass, are binarized using a combination of truncated Rice (TR) and Exp-Golomb (EG) codes, similar to remainder values in HEVC. The resulting bins are coded in the bypass mode of the coding engine. Unlike HEVC, the Rice parameter for the TR codes is derived based on the sum of absolute level values |q| in a local template T. The local template T used is the same as the template used for context index derivation in the first coding pass. The Rice parameter m is given by:

$$m = \{ \begin{matrix}0 , & {s}_{T} < 7 , \\ 1 , & 7 \leq {s}_{T} < 14 , \\ 2 , & 14 \leq {s}_{T} < 28 , \\ 3 , & {s}_{T} \geq 28 ,\end{matrix} , with {s}_{T} = {\sum }_{T} \vert q \vert - 5 {z}_{0} . \qquad ( 36 )$$

In some of the conventional technologies, two syntax elements that are coded in bypass arithmetic coding mode are the sign symbols of the transform coefficients and the magnitude (absolute level) symbols of the transform coefficients of respective CGs. Although the bypass arithmetic coding mode may be used to speed up the arithmetic coding process, compression of the symbols of these syntax elements coded in bypass arithmetic encoding mode is limited because their probability distributions are uniformly distributed (or at least assumed to be uniformly distributed). Information theory conveys that a symbol cannot be compressed at a rate less than its entropy without loss of information, and a symbol with a uniform probability distribution has maximum entropy. Thus, symbols coded using the bypass arithmetic encoding mode generally require more bits to encode than symbols encoded using the regular arithmetic encoding mode.

Some embodiments of the present disclosure are directed to apparatuses and methods for improving the compression efficiency of magnitude symbols of transform coefficients. Instead of entropy coding a magnitude symbol of the transform coefficient, embodiments of the present disclosure entropy encode an indication of whether a value of the magnitude symbol of the transform coefficient matches a value of the magnitude symbol of a transform coefficient candidate used as the predictor. The predictor may be selected from among a plurality of transform coefficient candidates (referred to herein as hypotheses) based on certain costs associated with each of the plurality of transform coefficient candidates. The cost of each transform coefficient candidate in the plurality of transform coefficient candidates may be calculated based on an energy discontinuity on the border of the current coding unit (current block) with one or more neighbor blocks. The energy discontinuity can be determined based on a difference between a template of selected samples of the current block and a template of corresponding samples from one or more neighboring blocks. The template of selected samples of the current block and the template of corresponding samples from neighboring blocks, can be on opposite sides of the boundary of the current block (see, e.g., samples 1704 and 1706 in FIG. 17). The indications of whether values of magnitude symbols of respective transform coefficients match values of magnitude symbols of respective transform coefficient predictors that are neighboring samples may have a non-uniform probability distribution and therefore may provide improved compression efficiency (e.g., by using regular mode in a CABAC encoder) over encoding the magnitude symbol of the transform coefficient based on a uniform probability distribution.

After the encoder selects a coefficient predictor from the set of transform coefficient candidates, the encoder may signal, in a bitstream, an indication of the predictor. The encoder may indicate the selected predictor in the bitstream by an index (e.g., index into the set of coefficient candidates), or one or more flags. The magnitude symbol of the transform coefficient in the current block may then be taken to be the same as the corresponding transform coefficient magnitude symbol in the predictor. The decoder may decode a predictively entropy encoded transform coefficient by decoding the indicator value included in the bitstream and, in accordance with the value of the indicator, deciding whether the magnitude symbol of the transform coefficient matches that of the predictor.

In some existing implementations, residuals are encoded using prefix codes, e.g., a combination of truncated Rice (TR) and Exp-Golomb (EG) codes. A binarized syntax element, a bin as referred to above, may be encoded using the CABAC encoder that selects a context model for the bin based on the position of the bin in the coded syntax element. Some bins and some of the symbols may be encoded in the bypass mode (also referred to as equiprobable mode, EP mode). A prefix code for a transform coefficient consists of two parts: prefix bins, and suffix bins. FIG. 22B shows that an (encoded or decoded) transform coefficient 2202 includes a sign component 2204, a flag component 2206 indicating whether the absolute level of the coefficient is greater than a predetermined threshold (e.g., 0), a prefix component 2208, and a suffix component 2210.

Prefix bins are encoded using a variable-length code (VLC), while suffix bins are defined by a fixed-length code, where a prefix value determines the number of bins in a suffix. In conventional techniques, suffix bins are coded in the bypass mode.

In an embodiment of the present disclosure, at least some suffix bins of a coefficients are not encoded directly, but instead, correctness of a selected hypothesis is indicated in the bitstream for each of those suffix bins. It was observed that it is more efficient to signal hypothesis check bins (i.e., bins encoding an indicator whether a selected hypothesis is correct) for the suffix bins at the most significant positions. The impact of most significant bin (MSB) suffix bins on the reconstructed residual is greater than of least significant bins (LSBs), and therefore the probability of a selected hypothesis being correct is also greater. Since a hypothesis is more probable to be correct, arithmetic encoding of the hypotheses check bins can be performed using a context model. In an embodiment, a hypothesis check bin having a value of 1 may mean that, from a plurality of transform coefficient candidates, the candidate that has the lowest cost (e.g., difference between a neighboring transform coefficient and the predicted transform coefficient for the current sample location) contains the transform coefficient that is most similar in magnitude to the transform coefficient to be encoded or decoded.

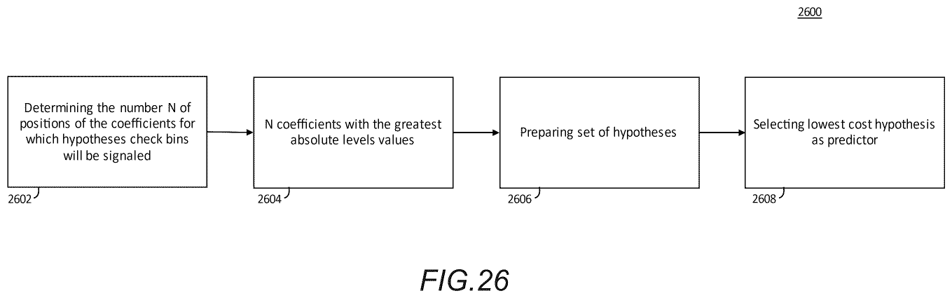

FIG. 26 shows an example hypotheses checking process 2600, according to some embodiments, that provides for selecting a hypothesis as the predictor. The hypotheses checking process 2600 comprises the following operations: determining the number N of positions of the coefficients, for which hypotheses check bins will be signaled; determining which bins of suffixes of coefficients are to be indicated by the means of hypotheses check bins; and preparing a set of hypotheses and selecting the most probable hypothesis as the predictor. In example encoder embodiments, the hypotheses check process 2600 may be performed when a transform block is being entropy encoded, and in example decoder embodiments, the hypotheses check process 2600 may be performed when a received transform block is to be decoded.

In operation 2602, the number N of positions of coefficients for which hypotheses check bins will be signaled is determined. The number N of positions is defined by a maximum value Nₘₐₓ and a number Nₐ of available coefficients, for which absolute levels are encoded by the means of prefix codes: N=min(Nₘₐₓ, Nₐ).

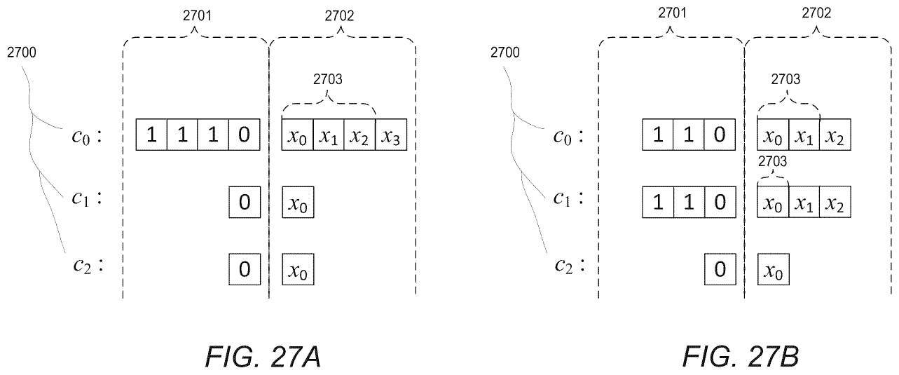

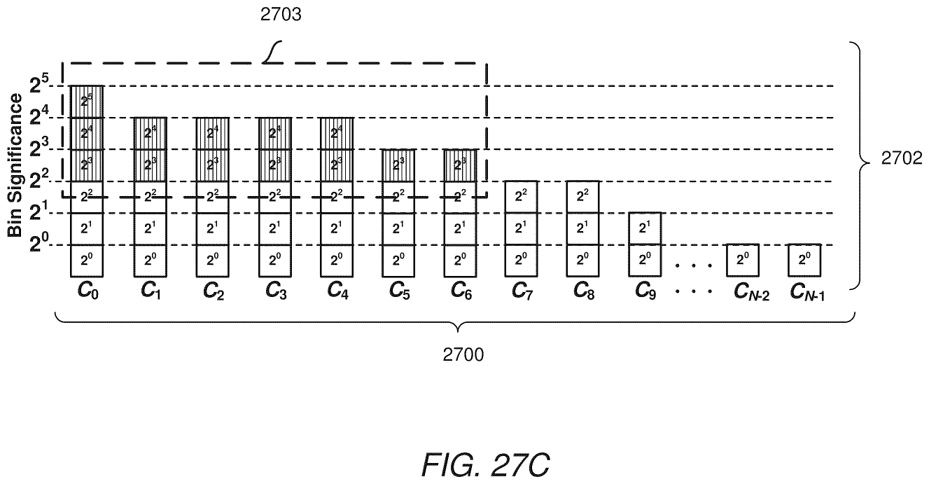

In operation 2604, determining of which bins of suffixes of coefficients are to be indicated by the means of hypotheses check bins is performed. The N coefficients with the greatest absolute levels values can be selected. FIG. 27A shows an example where N=3 coefficients 2700 are encoded using prefix codes for their absolute levels. The prefix code comprises a prefix part 2701 and suffix part 2702.

The maximum number of suffix bins that are to be encoded by hypothesis check bins may be predetermined. For example, the maximum number of suffix bins may be predefined such as for a slice, a picture, or a video sequence. Among the N coefficients 2700, the most significant suffix bins (MSBs) 2703 are selected so that hypotheses check bins are encoded instead of their values. That is, for each of the selected MSB of the most significant bins 2703, instead of encoding the actual value of that bin as would occur when the prefix code encodes the coefficient level, a hypothesis check bin is encoded.

FIG. 27B shows another example in which suffix bins of several coefficients are further selected to be signaled by means of hypotheses check bins. In this example, the most significant suffix bins 2703 are selected from two of the three coefficients 2700. The three bins are selected as two MSB from coefficient c₀ and one MSB from coefficient c₁.

FIG. 27C shows another example of a plurality of coefficients 2700, which are the quantized transformed coefficients of residuals (e.g., coefficients in a residual block). Specifically, the suffix part 2702 of coefficients 2700 are shown with each of the suffixes having a plurality of bins from the least significant bin 0 (representing value of 2\hat{ }0=1) at the bottom to the most significant bins up to bin 5 (representing value of 2\hat{ }5=32) towards the top. In some examples, based on the number of suffix bins to be selected, most significant bins 2703 (shown as gray bins) of the suffix part 2702 of coefficients 2700 may be selected to be coded as hypothesis check bins. In some examples, for bins of the same significance, bins earlier in the sequence of coefficients 2700 may be selected. For example, the residual block may include coefficients 2700 in a specific sequence such as from C₀ to C_{N-1}. For example, if 12 bins are to be selected to be coded as hypothesis check bins, the bins that are the most and second most significant and corresponding to significance 5 (with value 2⁵) and 4 (with value 2⁴) will be selected and totals 6 bins. Then, the next most significant bins, which correspond to significance 3 (with value 2³) will be selected in the order of coefficients from C₀ to C_{N-1} up to a total number of 12 bins. In this example, an additional bin will be selected from each of C₀ to C₅, but bin 23 for C₆ will not be selected.

Returning to FIG. 26, at operation 2606, the set of hypotheses is generated. This, for example, includes preparing a list of combinations of bin values for most significant suffix bins 2703. Such a combination is referred to in this disclosure as a hypothesis or coefficient candidate. In some embodiments, a hypothesis or coefficient candidate, may include all coefficients in the coding unit represented but with coefficients that include MSB that are predicted (i.e., for which hypothesis check bins will be transmitted) assigned different values corresponding to the combination that is represented by the hypothesis or coefficient candidate.

After the set of hypotheses is generated, in operation 2608 of process 2600, the most probable hypothesis is selected as the predictor. In some embodiments, the selection of the most probable hypothesis (i.e., the predictor) may be based on estimating an energy discontinuance or magnitude of a boundary artifact introduced by each of the hypotheses. In a bitstream, a result of comparing coefficients' bins of the most probable hypothesis with the actual coefficients' bins is signaled. The result that is signaled in the bitstream is referred to in this disclosure as a hypothesis check bin or an indication.

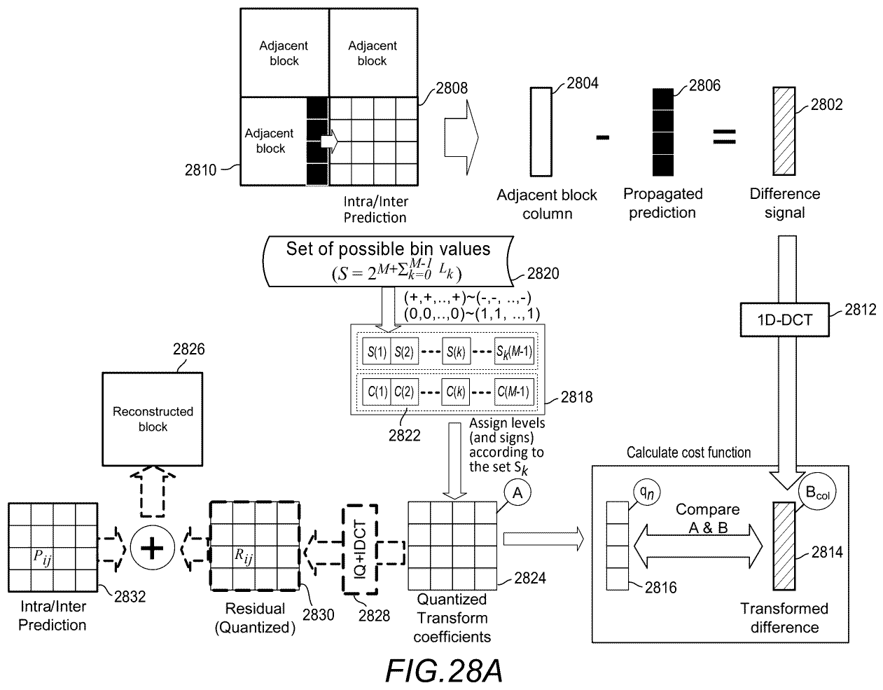

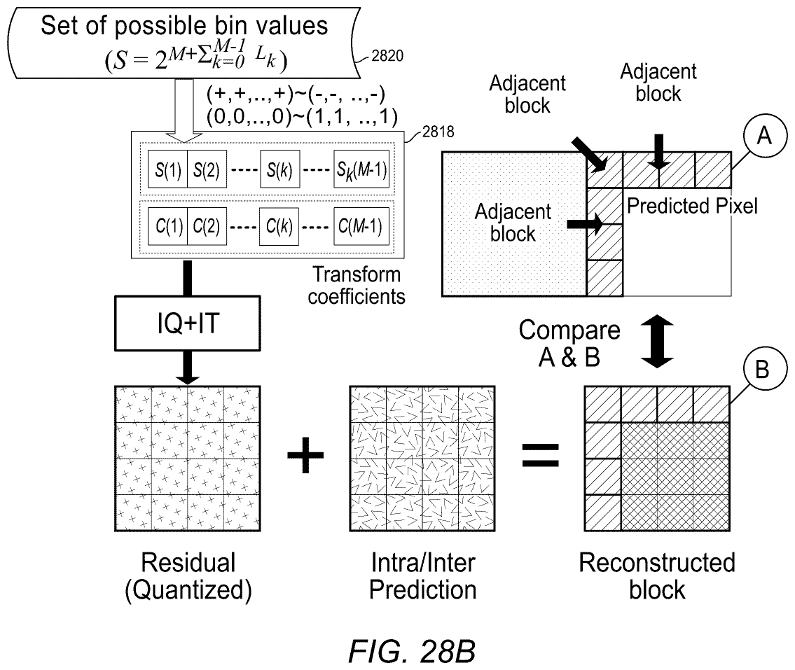

An example process of estimation of energy or magnitude of a boundary artifact according to some embodiments of this disclosure is shown in FIG. 28A. FIG. 28A is similar to FIG. 18 with the exception of the set of the set of possible bin values 2820 and the set of possible hypotheses 2818. In the example of FIG. 18, the set of possible bin values for generating the set of hypotheses included only the set of all possible sign values. In contrast, the set of possible bin values 2820 in embodiments of the present disclosure include all possible values for each suffix bin that is to be transmitted as a hypothesis check bin. In some embodiments, the set of hypotheses may additionally include all possible sign values for each coefficient for which the sign symbol is to be transmitted as a hypothesis check bin.

FIG. 28A provides an overview of a hypotheses generation for transform coefficient levels and optionally signs of transform coefficients and a transform domain hypothesis checking process that can be used in some embodiments. The difference signal 2802 for a set of selected boundary samples of the current block 2808 is calculated as the difference between reconstructed residuals for samples 2804 of an adjacent neighbor block 2810 and predicted values for boundary samples 2806 of the current block 2808. The values of the difference signal 2802 (corresponding to the boundary samples) are then 1D-transformed 2812 (e.g., DCT) to generate transformed differences 2814 comprising transform coefficients.

The transformed differences 2814 are compared to each hypothesis 2816 of the set of possible hypotheses 2818. The set of possible hypotheses 2818 may be generated by assigning, for each suffix bin that is to be represented by a hypothesis check bin, all possible values. That is, if a first MSB that is to be represented by a hypothesis check bin is 1 bit wide, then one hypothesis with a value of 1 in the first MSB and another hypothesis with a value of 0 in the first MSB are added to the set of hypotheses. In this manner, hypotheses are generated so that every possible combination of coefficient values is represented in the set of hypotheses. In embodiments that encode hypothesis check bins for sign symbols, every combination of all possible sign values and all possible coefficient values are represented in the set of hypotheses. That is, the set of hypotheses 2818 will have each possible bin value for each hypothesis bin (sign bin or suffix bin) represented. Coefficients and signs that are not represented by hypothesis check bins will have the same actual value in each hypothesis in the set of hypotheses.

In some examples, a cost function for each hypothesis 2816 (i.e., for the set of transform coefficients of hypothesis 2816) may be calculated based on comparing transformed differences 2814 and the hypothesis 2816. For example, the cost function may be based on a difference (e.g., sum of squared differences (SSD), sum of absolute differences (SAD), or sum of absolute transformed differences (SATD), etc., between coefficients of hypothesis 2816 and corresponding coefficients of transformed differences 2814). In some examples, one of the set of possible hypotheses 2818 may be selected as a predictor based on having a lowest cost. For example, the lowest cost form of the cost function may indicate the hypothesis results in a closest match to transformed difference 2814, thus resulting in the smallest estimated energy difference in the block boundary.

Block 2824 is the current block to be decoded before the quantized transform coefficients are decoded. In order to generate the set of possible hypotheses 2818, the set of all possible bin suffix values and the set of all possible sign values for coefficients and signs that are to be represented by hypotheses check bins are assigned in each possible combination to the set of transform coefficients of each hypothesis 2816 or to the transform coefficients block 2824 from which the set of transform coefficients of each hypothesis 2816 is obtained for comparing with transformed differences 2814. In the illustrated example, 2814 and 2816 are based on the left most columns in the current block 2808 and the block 2824, respectively. Since both 2814 and 2816 are in the transform domain, no inverse transform calculations are needed for the comparison. It should be noted that since the received transform coefficients of block 2824 are the result of samples being subjected to a 2D transform operation performed at encoding, a 1D transform is performed on the left column to obtain the sign-hypothesized transform coefficients of hypothesis 2816 to be compared to the set of coefficients of transformed difference 2814.

It will be noted that an inverse quantization and inverse transform 2828 is performed on the received transform coefficients of block 2824 (current block) to obtain residuals 2830 in the spatial domain that is then combined with the predictions 2832 to derive the reconstructed block 2826 corresponding to a decoding of the current block 2808.

For the sake of simplicity, only the column of the adjacent block is shown in FIG. 28A. It should be understood that the top row could also be used for hypothesis checking, for example, as illustrated in FIG. 17 where it was shown that the left-most column and the top-most row can both be used in the cost calculation. As with TDRSP, the basic idea underlying the concept of transform domain residual level prediction consists of estimating energy of discontinuity on the block boundary in transform domain without inverse transform of residual signal during hypothesis checking. For this purpose, the impact of prediction and residual signals on the energy of the discontinuity is estimated separately. Note that, as already discussed in relation to TDRSP above, estimating discontinuity using the L1 norm (sum of absolute differences) in the transform domain will not be applicable since linear transforms preserve energy of the signals but not their absolute values.

Example embodiments are not limited to estimating energy of discontinuity on the block boundary in the transform domain as in FIG. 28A, and in some embodiments can use estimating energy of discontinuity on the block boundary in the spatial domain as in FIG. 28B. In the example shown in FIG. 28B, the set of possible bin values 2820 and the set of possible hypotheses 2818 can be generated as described in relation to FIG. 28A. However, the predicted sample set “A” and the reconstructed sample set “B” are generated in the spatial domain, so that the comparison can occur in the spatial domain. Therefore, inverse quantization and inverse transform calculations are performed on the respective hypothesis of the set of possible hypotheses 2818 to obtain a corresponding block of residuals that is then added to a corresponding intra/inter prediction to obtain the reconstructed block from which the reconstructed sample set “B” is obtained.

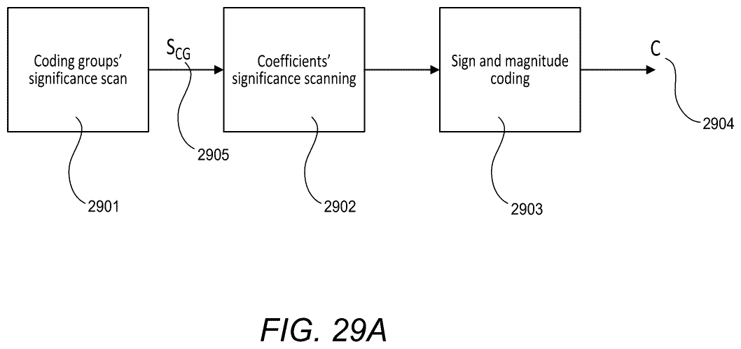

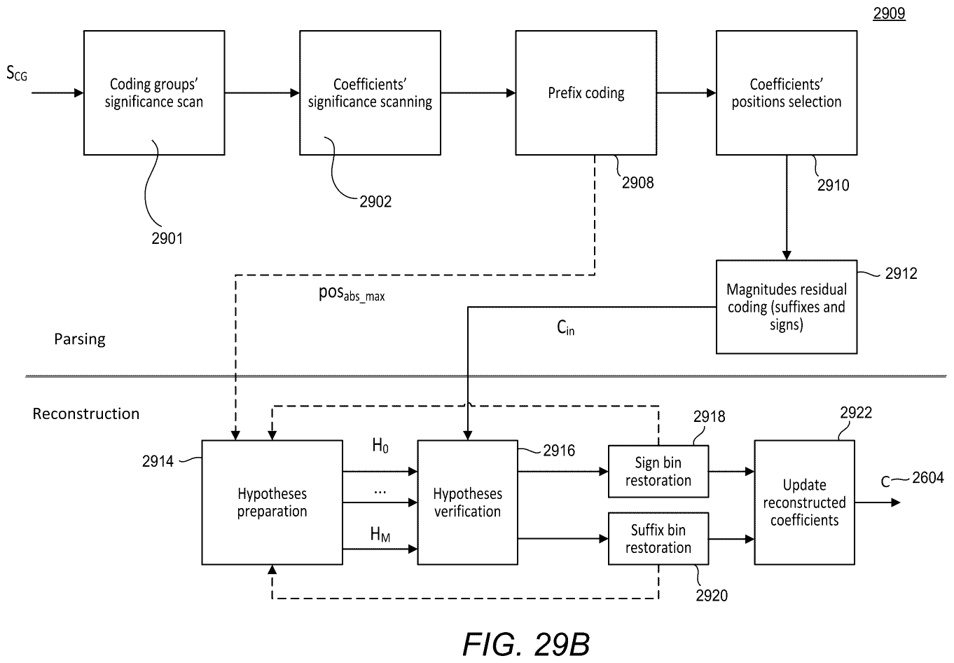

In FIG. 29A, a process of parsing a residual signal according to some embodiments of the present disclosure is shown. In operation 2901 an input bitstream is being parsed to restore significance of CGs. Operation 2901 may include unpacking compressed pluralities of CGs to respective CGs. These bins 2905 describing the respective CGs indicate what parts of restored coefficients matrix of each CG have non-zero coefficient values. In operation 2902, for each significant coding group (i.e., CGs having non-zero coefficients), symbols indicating which of the coefficients within the coding group have non-zero values are provided. Non-zero coefficients within significant coefficient groups are further coded using syntax elements that may represent the coefficient sign, a flag indicating whether an absolute level of the coefficient is greater than some threshold, and a remainder (i.e., a difference between and absolute level and the threshold). In operation 2903 sign and magnitude decoding of transform coefficients in the CGs, including at least some coefficients for which the magnitude symbol and optionally the sign symbol are predictively encoded by encoding, instead of their respective values, indicators of whether the values match respective hypotheses. As further described below, coefficients 2904 of decoded CGs are output from operation 2903.

FIG. 29B shows process 2909 to decode a signal with entropy coded predicted transform coefficients according to some embodiments. After operations 2901 and 2902 described above in relation to FIG. 29A, the operations shown in FIG. 29B describe the sign and magnitude coding operation 2903 in more detail.

After entering operation 2903, a prefix coding operation 2908 is performed. The processing is illustrated in two pipelines: a parsing pipeline including operations 2908, 2910 and 2912; and a reconstruction pipeline including operations 2914, 2916, 2918, 2920 and 2922. The prefix coding operation 2908 informs the hypothesis preparation operation 2914 of the reconstruction pipeline the positions of the predicted coefficients and the predicted most significant bins. Next, in the parsing pipeline, a coefficient position selection operation 2910 is performed and the magnitude residual coding is obtained at 2912 for each coefficient selected. In some embodiments, this includes predicting one or more suffixes and the sign for selected coefficients. Note that any suffix bin that is signaled at 2912 is not carrying an actual magnitude value, and instead, is a hypothesis check bin carrying an indicator of whether a hypothesis is correct.

In the reconstruction pipeline, when the hypothesis preparation operation 2914 is informed of the predicted coefficients positions, in some embodiments, it generates the set of all possible hypotheses. That set may include all combinations of all possible sign values and all possible bin values for the predicted suffix bins of the predicted coefficients. In some embodiments, each predicted suffix bin can take either value 1 or value 0, and the sign bit can either be plus (1) or minus (0).

The hypothesis verification operation 2916, calculates the costs for the respective hypotheses generated at hypothesis preparation operation 2914 and then selects one of the hypotheses as the predictor in accordance with a predetermined selection criteria. Some example cost calculation techniques were described above in relation to FIGS. 28A and 28B. In some embodiments, the predictor is selected as the hypothesis that yields a minimum cost. After a hypothesis is selected as the predictor, then in accordance with the value of the indication encoded in the corresponding suffix bin, it is determined whether the value to be decoded (i.e., the sign or suffix bin value being decoded) is equal to the selected hypothesis or another hypothesis. Note that, for each suffix bin, the decision is a binary decision (i.e. two hypotheses).

As each entropy encoded prediction for a sign bin and/or suffix bin is determined by the hypothesis verification operation 2916, the determined value is set to fixed in operations 2918 (i.e., for fixing a determined sign bin value) or 2920 (i.e., for fixing a determined suffix bin value), and the processing repeats with the next group of hypotheses to resolve the next predicted bin. Eventually, the reconstruction coefficients are updated at operation 2922 and the block of reconstructed coefficients 2904 is output from the decoder.

In another embodiment, absolute levels of coefficients are obtained using dependent quantization. When trellis-based quantization (also referred to as dependent quantization, DQ) is in use, an error in a least significant suffix bin may introduce very significant distortion. Thus, when DQ is in use, least significant suffix bins may be selected instead of MSB.

In another embodiment, coefficients are obtained by applying a non-orthogonal transform to the result of an orthogonal one. For example, LFNST applies non-separable transform to the most low-frequency part of the transformed coefficients. In such embodiments, when estimating hypotheses costs, it may be necessary to apply inverse LFNST for each of the hypothesis being checked.

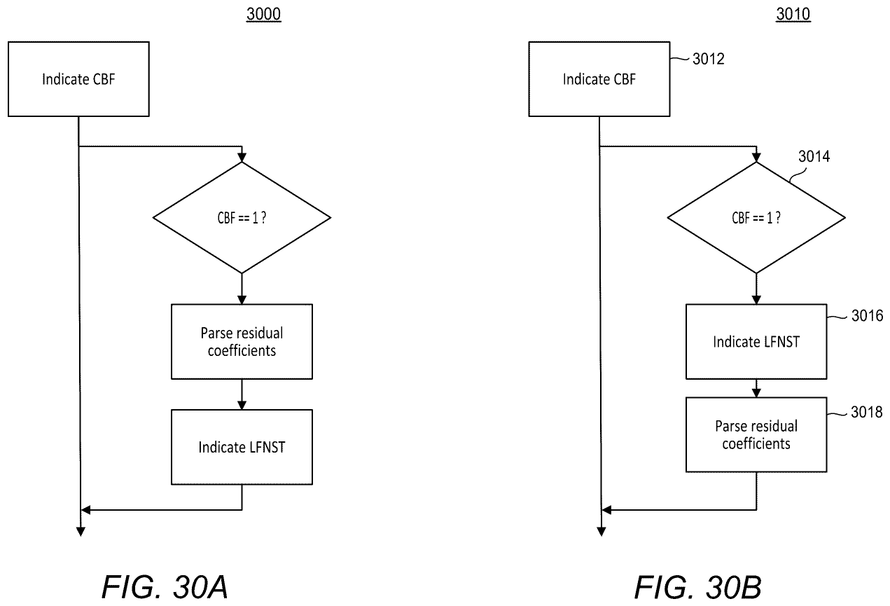

In another embodiment, hypotheses check may not be performed for blocks with coefficients of secondary transforms (e.g., LFNST). However, in the parsing process of a state-of-the-art decoder, LFNST is indicated only for the blocks that have at least one non-zero coefficient. This may be performed by a flag which is encoded prior to residual signal coding. FIG. 30A shows the current LFNST signaling process 3000 and FIG. 30B indicates how it can be reorganized into a process 3010 in example embodiments so that suffix bins prediction may be turned on or off based on the LFNST flag. For example, in the example embodiment shown in FIG. 30B, at operation 3012 an indication of CBF is detected, and at 3014 it is determined, based on the CBF flag, that the block contains at least one non-zero level. At operation 3016 it is determined whether the block included LFNST. Then, if at 3016 it is determined that the block does not include LFNST, then the parsing residual coefficients at operation 3018 may be performed using hypothesis check bins to take advantage of the capability to improve entropy coding of transform coefficients in the block. Alternatively, if at 3016 it is determined that the block does include LFNST, then the parsing residual coefficients at operation 3018 may be performed without the use of hypothesis check bins.

As noted previously in this disclosure, FIG. 19A illustrates an example implementation of a CABAC encoder 1900 in accordance with some embodiments of the present disclosure. CABAC encoder 1900 may be implemented in a video encoder, such as video encoder 200 in FIG. 2, for entropy encoding syntax elements of a video sequence. As illustrated in FIG. 19A, CABAC encoder 1900 includes a binarizer 1902, an arithmetic encoder 1904, and a context modeler 1906. Binarization in the binarizer 1902 maps the syntax elements to binary symbols (bins). Context modeling by the context modeler 1906 estimates the probability of each non-bypassed (i.e., regular coded) bin based on some specific context. Finally, binary arithmetic coding in the arithmetic encoder 1904 compresses the bins to bits according to the estimated probability.

CABAC encoder 1900 may receive a syntax element 1908 for arithmetic encoding. Syntax elements, such as syntax element 1908, may be generated at a video encoder and may describe how a video signal may be reconstructed at a video decoder. For a block, such as a coding unit (CU), the syntax elements may comprise transform coefficients. In some embodiments, each transform coefficient is represented by a sign component, prefix component and suffix component.

Binarizer 1902 may first map the value of syntax element 1908 to a sequence of binary symbols (also referred to as bins). Binarizer 1902 may define a unique mapping of values of syntax element 1908 to sequences of binary symbols. Binarization of syntax elements may help to improve probability modeling and implementation of arithmetic encoding. Binarizer 1902 may implement one or more binarization processes, such as unary, truncated unary, k-th order truncated Rice, k-th order exponential-Golomb (EGk), fixed-length, or some combination of two or more of these binarization processes. Binarizer 1902 may select a binarization process based on a type of syntax element 1908 and/or one or more syntax elements processed by CABAC encoder 1900 before syntax element 1908. Based on syntax element 1908 already being represented by a sequence of one or more binary symbols, binarizer 1902 may not process syntax element 1908. In another example, binarizer 1902 may not be used and syntax element 1908 represented by a sequence of one or more non-binary symbols may be directly encoded by CABAC encoder 1900.

After binarizer 1902 optionally maps the value of syntax element 1908 to a sequence of binary symbols, one or more of the binary symbols may be processed by arithmetic encoder 1904. Arithmetic encoder 1904 may process each of the one or more binary symbols in one of at least two modes: regular arithmetic encoding mode or bypass arithmetic encoding mode.

Arithmetic encoder 1904 may process binary symbols that do not have a uniform (or approximately uniform) probability distribution in regular arithmetic encoding mode (e.g., binary symbols that do not have a probability distribution of 0.5 for each of their two possible values). In regular arithmetic encoding mode, arithmetic encoder 1904 may perform arithmetic encoding as described above. For example, arithmetic encoder 1904 may subdivide a current coding interval into m disjoint subintervals. Each of the m disjoint subintervals may have a width proportional to the probability of the binary symbol having a different one of the values in an m-ary source alphabet. In the case of a binary symbol, m is equal to two and the current coding interval may be subdivided into two disjoint intervals that each have a width proportional to the probability of a different one of the two possible values {0, 1} for the binary symbol being encoded. The probabilities of the two possible values for the binary symbol may be indicated by a probability model 1910 for the binary symbol. Arithmetic encoder 1904 may then encode the binary symbol by choosing the subinterval corresponding to the actual value of the binary symbol as the new coding interval for the next binary symbol to be encoded.

Arithmetic encoder 1904 may receive probability model 1910 from context modeler 1906. Context modeler 1906 may determine probability model 1910 for the binary symbol by a fixed selection (e.g., based on a position of the binary symbol in the sequence of binary symbols representing syntax element 1908) or by an adaptive selection from among two or more probability models (e.g., based on information related to the binary symbol). As shown in FIG. 19A, probability model 1910 may comprise two parameters: the probability P_{LPS} of the least probable symbol (LPS) and the value v_{MPS} of the most probable symbol (MPS). In other examples, probability model 1910 may comprise the probability P_{MPS} of the MPS in addition or alternatively to the probability P_{LPS} of the LPS. Similarly, in other examples, probability model 2610 may comprise the value v_{LPS} of the LPS in addition or alternatively to the value v_{MPS} of the MPS. After arithmetic encoder 1904 encodes the binary symbol, arithmetic encoder 1904 may provide one or more probability model update parameters 1912 to context modeler 1906. Context modeler 1906 may adapt probability model 1910 based on the one or more probability model update parameters 1912. For example, the one or more probability model update parameters 1912 may comprise the actual coded value of the binary symbol. Context modeler 1906 may update probability model 1910 by increasing P_{LPS} if the actual coded value of the binary symbol is not equal to v_{MPS} and by decreasing P_{LPS} otherwise.

Arithmetic encoder 1904 may process binary symbols that have (or are assumed to have) a uniform (or approximately uniform) probability distribution in bypass arithmetic encoding mode. Because binary symbols processed by arithmetic encoder 1904 in bypass arithmetic encoding mode have (or are assumed to have) a uniform (or approximately uniform) probability distribution, arithmetic encoder 1904 may bypass probability model determination and adaptation performed in regular arithmetic encoding mode when encoding these binary symbols to speed up the encoding process. In addition, subdivision of the current coding interval may be simplified given the uniform (or assumed uniform) probability distribution. For example, the current coding interval may be partitioned into two disjoint subintervals of equal width, which may be realized using a simple implementation that may further speed up the encoding process. Arithmetic encoder 1904 encodes the binary symbol by choosing the subinterval corresponding to the value of the binary symbol as the new coding interval for the next binary symbol to be encoded. The resulting increase in encoding speed for binary symbols encoded by arithmetic encoder 1904 in bypass arithmetic encoding mode is often important because CABAC encoding may have throughput limitations.

After processing a number of binary symbols (e.g., corresponding to one or more syntax elements), arithmetic encoder 1904 may determine a value in the range of the final coding interval as an arithmetic code word 1914 for the binary symbols. Arithmetic encoder 1904 may then output arithmetic code word 1914. For example, arithmetic encoder 1904 may output arithmetic code word 1914 to a bitstream that may be received and processed by a video decoder.

In the example of FIG. 19B, the encoder may entropy encode an indication 1938 (also referred to as hypothesis check bin) using arithmetic encoder 1942. In example embodiments, the indication 1938 is output by logic 1940 based on comparing the value 1917 of a bin of a transform coefficient of the transform coefficient to be encoded and the value 1916 of the corresponding bin of the transform coefficient of the predictor. For example, during operation 3106 after having selected a coefficient candidate (hypothesis) as a predictor, the encoder may entropy encode the indication 1938 of whether the value 1917 of a suffix bin (of magnitude symbol) of the transform coefficient to be encoded matches the value 1916 of the corresponding suffix bin of the magnitude symbol of the transform coefficient in the predictor. For example, when bin value 1917 of the coefficient to be encoded has a value which matches the value 1916 of the coefficient of the predictor, then the indication 1938 is assigned a value of 1. If logic 1940 determined the values 1916 and 1917 do not match, then a value of 0 is assigned to indication 1938. An indication 1938 can also be output for sign symbols from the coefficient to be encoded and a coefficient from the predictor, in a manner similar to how the indication 1938 for suffix bins is determined. In one example, logic 1940 may implement a logical exclusive or (XOR) function that takes as input value 1917 and value 1916 and outputs indication 1938. It should be noted that in other examples where value 1916 is non-binary, indication 1938 may indicate the first candidate among the plurality of candidates (e.g., as sorted based on their respective costs) that has a value of the suffix (or the sign) the coefficient to be encoded that matches the value of the suffix (or the sign) in the predictor.

Based on the method of determining indication 1938 as described above, indication 1938 may have a non-uniform probability distribution. Therefore, arithmetic encoder 1942 may process indication 1938 in regular arithmetic encoding mode as described above. For example, arithmetic encoder 1942 may subdivide a current coding interval into m disjoint subintervals. Each of the m disjoint subintervals may have a width proportional to the probability of the symbol being encoded having a different one of the values in an m-ary source alphabet. In the case of indication 1938, which is binary, m is equal to two and the current coding interval may be subdivided into two disjoint intervals that each have a width proportional to the probability of a different one of the two possible values {0, 1} for indication 1938 being encoded. The probabilities of the two possible values for indication 1938 may be indicated by a probability model 1944 for indication 1938. Arithmetic encoder 1942 may then encode indication 1938 by choosing the subinterval corresponding to the actual value of indication 1938 as the new coding interval for the next binary symbol to be encoded.

Arithmetic encoder 1942 may receive probability model 1944 from context modeler 1946. Context modeler 1946 may determine probability model 1944 for indication 1938 by a fixed selection or an adaptive selection from among two or more probability models. For example, context modeler 1946 may determine probability model 1944 by a fixed selection or an adaptive selection from among two or more probability models based on a position of transform coefficient in the CG or in the coefficient block and/or the position of the suffix bin or an index of (e.g., a value indicating) an above noted position. The position (or index of the position) of the transform coefficient or the suffix bin may provide an indication of the likelihood of the value of predictor matching the value of transform coefficient.

For adaptive selection from among two or more probability models, context modeler 1946 may compare the position (or index of the position) of the transform coefficient and/or the suffix bin to one or more thresholds and configure the probability model accordingly.

As shown in FIG. 19B, probability model 1944 may comprise two parameters: the probability P_{LPS} of the least probable symbol (LPS) for indication 1938 and the value v_{MPS} of the most probable symbol (MPS) for indication 1938. In other examples, probability model 1944 may comprise the probability P_{MPS} of the MPS for indication 1938 in addition or alternatively to the probability P_{LPS} of the LPS for indication 1938. Similarly, in other examples, probability model 1944 may comprise the value v_{LPS} of the LPS for indication 1938 in addition or alternatively to the value v_{MPS} of the MPS for indication 1938. After arithmetic encoder 1942 encodes indication 1938, arithmetic encoder 1942 may provide one or more probability model update parameters 1950 to context modeler 1946. Context modeler 1946 may adapt probability model 1944 based on the one or more probability model update parameters 1950. For example, the one or more probability model update parameters 1950 may comprise the actual coded value of indication 1938. Context modeler 1946 may update probability model 1944 by increasing P_{LPS} for indication 1938 if the actual coded value of indication 1938 is not equal to v_{MPS} and by decreasing P_{LPS} for indication 1938 otherwise.

After processing a number of binary symbols (e.g., corresponding to one or more syntax elements), arithmetic encoder 1942 may determine a value in the range of the final coding interval as an arithmetic code word 1952 for the binary symbols. Arithmetic encoder 1942 may then output arithmetic code word 1952. For example, arithmetic encoder 1942 may output arithmetic code word 1952 to a bitstream that may be received and processed by a video decoder.

FIG. 19C illustrates an example of a decoder (e.g., decoder 300 in FIG. 3) that may receive arithmetic code word 1952, arithmetically decode the indication 1938 from arithmetic code word 1952, and use indication 1938 to determine the value 1916 of the bin of the magnitude symbol of the transform coefficient to be decoded in accordance with embodiments of the present disclosure.

The decoder may receive arithmetic code word 1952 in a bitstream. The decoder may provide arithmetic code word 1952 to an arithmetic decoder 1954. Based on the method of determining indication 1938 as described above, indication 1938 may have a non-uniform probability distribution. Therefore, arithmetic decoder 1954 may process indication 1938 in regular arithmetic decoding mode. For example, arithmetic decoder 1954 may perform recursive interval subdivision as explained above to decode symbols encoded by arithmetic code word 1952. For example, arithmetic decoder 1954 may arithmetically decode a symbol that takes a value from an m-ary source alphabet by dividing an initial coding interval into m disjoint subintervals. Each of the m disjoint subintervals may have a width proportional to the probability of the symbol having a different one of the values in the m-ary source alphabet. In the case of binary symbols like indication 1938, m is equal to two and the initial coding interval may be subdivided into two disjoint intervals that each have a width proportional to the probability of a different one of the two possible values {0, 1}. The probabilities of the symbol having the different values in the m-ary source alphabet may be referred to as a probability model for the symbol as mentioned above. The symbol is arithmetically decoded from arithmetic code word 1952 by determining the symbol value corresponding to the subinterval in which the arithmetic code word falls within. The decoder may sequentially decode each symbol sᵢ of a sequence s={s₁, s₂, . . . , s_{N}) encoded by arithmetic code word 1952 by recursively applying this interval-subdivision scheme N times and determining which subinterval arithmetic code word 1952 falls within during each iteration.

When decoding the symbol corresponding to indication 1938, arithmetic decoder 1954 may receive probability model 1944 for indication 1938 from context modeler 1946. Context modeler 1956 may determine probability model 1944 for indication 1938 by a fixed selection or by an adaptive selection from among two or more probability models in the same manner as described above for context modeler 1946 in FIG. 19B.

As shown in FIG. 19C, after arithmetic decoder 1954 decodes indication 1938 (e.g., hypothesis check bin), the value 1918 of the suffix bin of the coefficient to be decoded is determined by logic 1958 based on the indication 1938 and the value 1916 of the transform coefficient of the predictor. For example, during operation 3208 after having selected a coefficient candidate (hypothesis) as a predictor, the decoder, in logic 1958, may use the value of indication 1938 to determine whether the value 1918 of a suffix bin (of magnitude symbol) of the transform coefficient to be decoded matches the value 1916 of the corresponding suffix bin of the magnitude symbol of the transform coefficient in the predictor. For example, when the indicator value is 1, then the bin of the transform coefficient to be decoded has a value which matches the value 1916 of the coefficient of the predictor, and then the value 1918 of the bin of the coefficient to be decoded is assigned a value of 1. If logic 1958 determines the values 1916 and indication 1938 do not match, then a value of 0 is assigned to value 1918. A value 1918 for a sign bin for the coefficient to be decoded can also be output based on the indication 1938 and a coefficient from the predictor in a manner similar to how the value for suffix bins is determined. In one example, logic 1958 may implement a logical exclusive or (XOR) function. It should be noted that in other examples where value 1916 is non-binary, indication 1938 may indicate the first candidate among the plurality of candidates (e.g., as sorted based on their respective costs) that has a value of the suffix (or the sign) the coefficient to be encoded that matches the value of the suffix (or the sign) in the predictor.

Arithmetic decoder 1954 may provide one or more probability model update parameters 1950 to context modeler 1956. Context modeler 1956 may adapt probability model 1944 based on the one or more probability model update parameters 1950. For example, the one or more probability model update parameters 1950 may comprise the actual decoded value of indication 1938. Context modeler 1956 may update probability model 1944 by increasing P_{LPS} for indication 1938 if the actual decoded value of indication 1938 is not equal to v_{MPS} and by decreasing P_{LPS} for indication 1938 otherwise.

After entropy decoding indication 1938, the decoder may determine the value 1918 of the suffix bin (of magnitude symbol) of the transform coefficient to be decoded based on the value 1916 of the corresponding bin of the transform coefficient of the predictor and the indication 1938. For example, the decoder may determine the value 1918 of the bin of the magnitude symbol of the transform coefficient to be decoded as being equal to the value 1916 of the bin of the magnitude symbol of the coefficient predictor based on indication 1938 indicating that the values 1916 and 1918 match. Conversely, the decoder may determine the value 1918 of the suffix bin (of magnitude symbol) of the transform coefficient to be decoded as being not equal to (or equal to the opposite value of) the value 1916 of the corresponding bin of the transform coefficient of the predictor based on indication 1938 indicating that the values 1916 and 1918 do not match. In one example, indication 1938 may be a single bit that has the value: “0” when the value 1918 of the bin of the magnitude symbol of the coefficient to be decoded matches the value 1916 of the bin of the magnitude symbol of the coefficient predictor; and “1” when the value 1918 of the bin of the magnitude symbol of the coefficient to be decoded does not match the value 1916 of the bin of the magnitude symbol of the coefficient predictor. Logic 1958 may be used to determine the value 1918 of the bin of the magnitude symbol of the coefficient to be decoded. In one example, logic 1958 may implement a logical XOR function. It should be noted that in other examples where the value 1916 is non-binary, indication 1938 may indicate the first candidate among the plurality of candidates (e.g., as sorted based on their respective costs) that has a value 1918 of the magnitude symbol of the coefficient to be decoded that matches the value 1916 of the magnitude symbols of the coefficient predictor.

It should be noted that the approach discussed above with respect to FIGS. 19A-C to entropy code an indication of whether a value of a magnitude symbol of a coefficient matches a value of the magnitude symbol of a coefficient candidate used as a predictor of the coefficient may be applied to multiple magnitude symbols of the coefficient.

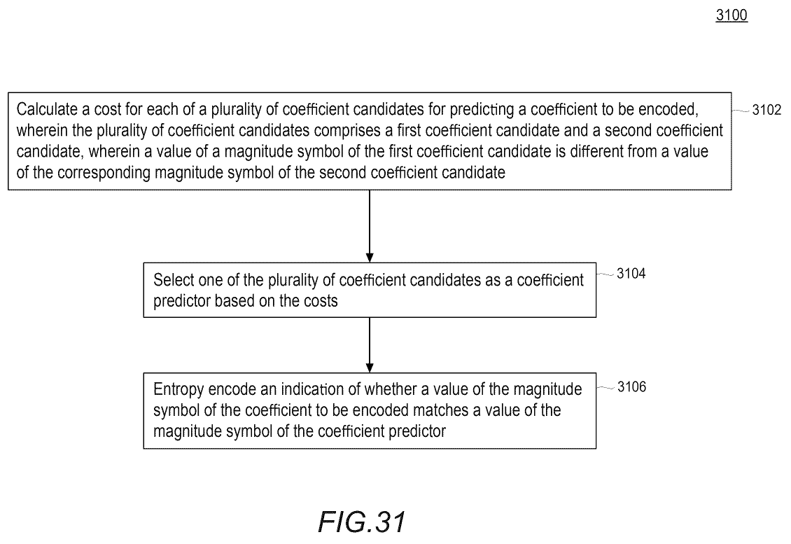

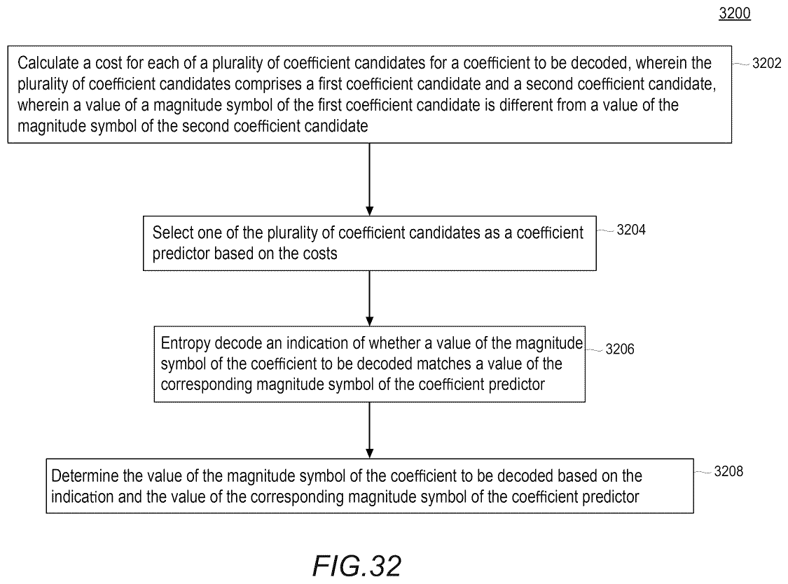

FIGS. 31 and 32 illustrate example processes performed by an encoder and decoder, respectively, according to some embodiments. As described above, the bitstream from an encoder to a decoder comprises entropy encoded transform coefficients that correspond to residuals calculated for respective samples in a picture. As noted above, for example, in relation to FIG. 22B, each transform coefficient may be encoded as a set of syntax elements that correspond to the sign of the transform coefficient, a flag indicating whether the absolute value of the transform coefficient is above a threshold (e.g., above zero), and the absolute level value (magnitude) of the transform coefficient specified as a prefix code. The prefix code consists of a prefix part that specifies an offset for the suffix, and the suffix. Each syntax element is represented by one or more bins. In example embodiments, at least some of the transform coefficients are predictively encoded by entropy encoding a hypothesis check bin (an indicator) instead of the actual value for the magnitude symbol, or more specifically, for the corresponding suffix bin(s). In some example embodiments, some transform coefficients may additionally have a hypothesis check bin (an indicator/indication) for the sign symbol entropy encoded instead of the corresponding sign. As described above, the use of hypothesis check bins that represent whether hypotheses are correct for the level/magnitude and optionally the sign of transform coefficients enables more efficient entropy coding of transform coefficients using the regular mode in CABAC.

FIG. 31 illustrates a method 3100 for entropy encoding an indication (also referred to as hypothesis check bin) of whether a value of a magnitude symbol of a transform coefficient that is to be encoded matches a value of the corresponding magnitude symbol of a coefficient candidate (a hypothesis) selected as a predictor in accordance with some embodiments of the present disclosure. Additionally, in some embodiments, the indication or another indication may indicate whether the sign symbol of the transform coefficient that is to be encoded matches the sign symbol of the coefficient candidate selected as the predictor. The method 3100 may be implemented by an encoder, such as, for example, encoder 200 shown in FIG. 2.

The method 3100 begins at operation 3102 when a transform coefficient in a current block is to be entropy encoded, for example, in the entropy encoding unit 218. It is noted that a picture being encoded is represented by one or more transform blocks and each transform block is considered as a plurality of CGs. Each transform coefficient to be encoded is located in one of the plurality of CGs. The current block (coding unit) may be the CG in which the transform coefficient to be encoded is located. Predetermined parameters may specify per transform block and/or per CG a number of coefficients and/or a number of most significant suffix bins that are to be represented by hypothesis check bins. For example, one or more transform coefficients that have the highest absolute level value (i.e., highest absolute level/magnitude) in the CG and/or are located in a predetermined area adjacent to the top left corner of the CG may be identified for hypothesis check bin encoding.

At operation 3102, the encoder may generate a set of coefficient candidates (hypotheses) for predicting the transform coefficient that is to be encoded. According to an embodiment, each coefficient hypothesis (i.e., coefficient candidate) contains a unique combination of values for the one or more suffix bins that are to be represented by indications of prediction results (e.g., also referred to as hypothesis check bins). For example, the one or more suffix bins may be a number of most significant suffix bins (or corresponding most significant magnitude symbols) selected from the coefficient (e.g., transform coefficient) to be coded. For example, the set of coefficient candidates (e.g., a plurality of coefficient candidates) may include a first coefficient candidate and a second coefficient candidate, and a value of a magnitude symbol of the first coefficient candidate is different from a value of the magnitude symbol of the second coefficient candidate. The first coefficient candidate and the second coefficient candidate may include the same values for magnitude symbols that are directly encoded. The one or more magnitude symbols that are directly encoded are not magnitude symbols corresponding to the one or more suffix bins to be represented by indications of prediction results. As explained above, these magnitude symbols may be entropy coded in a bypass mode of the entropy coder.

In some embodiments, all such unique combinations of values of the one or more suffix bins to be represented as indications of prediction results are represented in the set. In an example, if one suffix bin is to be a hypothesis check bin, a first hypothesis and a second hypothesis can be generated such that the two hypotheses differ only in the bin value (e.g., 1 or 0) of that suffix bin. In some embodiments, the set also includes, for each of the unique combinations of suffix bin values a hypothesis for each possible sign. For example, the set of hypotheses for coefficient c₀ that is to have only suffix bins x₀ and x₁ represented as hypothesis check bins may include respective hypotheses for the x₀, x₁ and x₂ bin value combinations 101, 111, 001, and 011. When the sign for c₀ is also to be predictively encoded, the set may include +101, −101, +111, −111, +001, −001, +001, and −001. The generation of the set of hypotheses can be performed, for example, as described in relation to operation 2606 in FIG. 26, FIGS. 28A, 28B and/or hypothesis preparation operation 2914 shown in FIG. 29B. As shown in FIGS. 27A-C, the values in the set may be for the number of the most significant bins selected or determined for a specific coefficient.

A cost is calculated for each of the coefficient candidates in the set of coefficient candidates. In some embodiments, the cost may be determined based on an energy discontinuance on one or more borders of the current block and can be calculated in the manner described in relation to FIG. 28A or FIG. 28B above. In some embodiments, the cost is determined in the transform domain while reducing the computational overhead of switching between transform domain and spatial domain. For example, as shown in FIG. 28A, each coefficient candidate can be compared to a set of predicted transform coefficients. However, embodiments are not limited to calculating costs in the transform domain, and in some embodiments, may calculate the costs in the spatial domain as shown in FIG. 28B.

At operation 3104, the encoder selects one of the plurality of coefficient candidates as the coefficient predictor based on calculated costs. In an embodiment, the encoder selects the coefficient candidate that has the smallest calculated cost as the coefficient predictor. Selection of the minimum cost coefficient candidate can be performed, for example, as described in relation to operation 2608 in FIG. 26 and/or operation 2916 shown in FIG. 29B.

At operation 3106, for each predicted suffix bin, the encoder entropy encodes an indication (e.g., referred to as hypothesis check bin) indicating whether the magnitude symbol of the transform coefficient to be encoded matches a value of the corresponding magnitude symbol of the coefficient predictor. In an example, the encoder may arithmetically encode the indication (e.g., hypothesis check bin) based on a probability model. The probability model may indicate a probability of a least probable symbol for the indication, and a value of a most probable symbol for the indication. The encoder may select the probability model from a plurality of probability models based on a position of the bin (corresponding to the indication) in the suffix and/or the location of the coefficient in the current block. In another example, the encoder may select the probability model from among the plurality of probability models based on a change in value of the transform coefficient for an incremental change in value of the bin, of the transform coefficient, corresponding to the indication. For example, the encoder may select the probability model from among the plurality of probability models based on a comparison of the change in value of the transform coefficient to one or more thresholds. In some embodiments, in addition to entropy encoding indications for one or more suffix bins for a transform coefficient in the regular mode of CABAC, the sign symbol is also represented by an entropy encoding an indication of a prediction result of the sign symbol.

FIG. 32 illustrates a method 3200 for entropy decoding an indication (also referred to as hypothesis check bin) that indicates whether a value of a magnitude symbol of a transform coefficient to be decoded matches a value of the corresponding magnitude symbol of a corresponding coefficient predictor (also referred to as a selected coefficient hypothesis) and using the value of the indication to determine a magnitude symbol of the transform coefficient to be decoded, in accordance with some embodiments of the present disclosure. In some embodiments, in addition to decoding indication for a suffix bin, the sign of the transform coefficient is also determined by decoding an indication corresponding to the sign symbol. The method 3200 may be implemented by a decoder, such as decoder 300 in FIG. 3. In an example embodiment, method 3200 may be used in entropy decoding a picture that has been entropy encoded by the method 3100 described above in relation to FIG. 31.

The method 3200 begins at operation 3202, for example, when a received entropy encoded transform coefficient is to be decoded. At operation 3202, the decoder generates a set of coefficient candidates (hypotheses) for predicting the transform coefficient that is to be decoded. For example, the set of coefficient candidates may be generated based on information regarding the positions of the predictively encoded coefficients in the CG and the suffix bins that are predictively encoded. The set of indications can be generated in a manner similar to that described in relation to how the set of coefficient candidates is generated in operation 3102 during the encoder process of method 3100. For example, each coefficient hypothesis (i.e., coefficient candidate) contains a unique combination of values for the one or more suffix bins that are to be represented by hypothesis check bins (or the indications of prediction result). For example, the set of coefficient candidates (e.g., a plurality of coefficient candidates) may include a first coefficient candidate and a second coefficient candidate, and a value of a magnitude symbol of the first coefficient candidate is different from a value of the magnitude symbol of the second coefficient candidate. The first coefficient candidate and the second coefficient candidate may include the same values for magnitude symbols that are directly encoded and decoded. In other words, the plurality of coefficient candidates may differ only in one or more symbols to be predictively coded. As explained above, these magnitude symbols may be entropy decoded in a bypass mode of the entropy coder. As described in relation to FIG. 29B, the hypotheses preparation operation 2914 receives information regarding the positions of the suffix bins that are to be represented by indications of prediction results (also referred to as hypothesis check bins).

The decoder calculates a cost for each of a plurality of hypothesis. The cost calculation can be performed in a manner similar to that described in relation to method 3100. For example, the cost for each coefficient candidate may be based on an estimated energy difference on a block boundary of a coefficient group in which the coefficient to be decoded is located.

In an example, the estimated energy difference on the block boundary is determined based on a difference between values of a plurality of reconstructed neighbor block samples adjacent to a boundary of a current block and predicted values of a plurality of samples adjacent to the boundary in the current block. The predicted values may be derived from values of a second plurality of reconstructed neighbor block samples.

In an example, the cost for each coefficient candidate may be determined based on the estimated energy difference and the coefficients of each coefficient candidate in transform domain. For example, the cost for each coefficient candidate may be determined further by performing one-dimensional transform of the difference from the spatial domain to the transform domain, as described above in FIG. 28A.

In some examples, the entropy decoded coefficient includes a sign value, a prefix value, and a suffix value. In an example, the most significant symbol of the suffix value is encoded (and also decoded) as the indication. In some examples, for the (transform) coefficient with a first number of magnitude symbols (e.g., in the suffix) to be encoded and decoded using the first number of indications indicating prediction results, the first number of magnitude symbols may corresponding to the first number of most significant symbols of the suffix of the coefficient.

At operation 3204, the decoder selects one of the plurality of coefficient candidates as a coefficient predictor based on the calculated costs. In an example, the decoder may select the coefficient candidate that has the lowest cost as the coefficient predictor.

At 3206, the decoder entropy decodes an indication of whether a value of the magnitude symbol of a transform coefficient to be decoded matches a value of the corresponding magnitude symbol of the coefficient predictor. In an example, the decoder may arithmetically decode the indication based on a probability model. The probability model may indicate a probability of a least probable symbol for the indication and a value of a most probable symbol for the indication. In an example, the decoder may select the probability model from a plurality of probability models based on a position of the magnitude symbol in the transform coefficient to be decoded. In an example, the decoder may select the probability model from a plurality of probability models based on a change in value of the transform coefficient to be decoded for an incremental change in value of the hypothesis check bin. For example, the decoder may select the probability model from the plurality of probability models based on a comparison of the change in the value of the transform coefficient to be decoded to one or more thresholds.

In some examples, one or more indications (e.g., the first number of indications described in operation 3202 and the indication of operation 3202) may be decoded in a regular mode of a CABAC coder. One or more magnitude symbols, that are not predictively coded using indications/hypothesis check bins), of the coefficient may be decoded in a bypass mode of the CABAC coder.

At operation 3208, the decoder determines a value of the magnitude symbol of the transform coefficient to be decoded based on the value of the corresponding magnitude symbol of the coefficient predictor and the indication (e.g., value of the indication of whether the predicted value is accurate). In an example, the decoder determines the value of the magnitude symbol of the transform coefficient to be decoded as being equal to the corresponding magnitude symbol of the coefficient predictor based on the indication indicating (e.g., value of 1) that the value of the magnitude symbol of the transform coefficient to be decoded matches the value of the magnitude symbol of the corresponding coefficient predictor. In another example, the decoder determines the value of the magnitude symbol of the transform coefficient to be decoded as being not equal to the corresponding magnitude symbol of the coefficient predictor based on the indication indicating (e.g., value of 0) that the value of the magnitude symbol of the transform coefficient to be decoded does not match the value of the corresponding magnitude symbol of the coefficient predictor.

In some examples, the coefficient to be decoded is in a coefficient group. The coefficient group may be selected from a plurality of coefficient groups in a transform block that comprises a matrix of transform coefficients. As part of decoding the coefficient, the decoder may entropy decode, for the transform block, a flag and a last non-zero coefficient location in the matrix. In an example, the decoder may determine, for the coefficient group, predicted coefficients (e.g., positions in the coefficient group indicating corresponding coefficients) based on absolute values of the coefficients. Based on the one or more selected coefficients whose symbols (e.g., sign symbol and/or one or more magnitude symbols) are to be predictively coded, the decoder may determine whether and how many coefficient candidates are to be generated to predictively code a number of predictively coded symbols of each of the one more selected coefficients.

In an example, the number of predicted coefficients may be based on a maximum number of precited coefficients. This maximum number may be predetermined. For example, the number of coefficients with the highest absolute values may be determined to have one or more symbols predictively coded.

Based on determining the set (or plurality) of coefficient candidates, as described in operation 3202, costs for each coefficient candidate may be calculated. For the coefficient to be predictively coded, the encoder may perform reciprocal operations as the decoder in selecting the one or more coefficients to be predictively coded and which one or more symbols of those selected coefficients are to be predictively coded.

In some examples, the decoder (and encoder may reciprocally) determine one or more symbols (e.g., sign symbol and/or one or more magnitude symbols in the suffix) of the coefficient to be predictively coded. For example, a number of the one or more symbols is based on a total number of predicted symbols selected from coefficients of a coefficient group comprising the coefficient. The number of the plurality of coefficient candidates may be equal to a power of two with an exponent of the number of the one or more predicted symbols. In an example, the one or more symbols include at least a sign symbol and a magnitude symbol. In an example, the one or more symbols are the most significant magnitude symbols of the coefficient.

In some examples, if the one or more symbols of the coefficient include the sign symbol and at least one magnitude symbol (e.g., of the suffix of a codeword representing the coefficient), the sign symbol may be predictively coded as an indication (e.g., “second indication”), of whether a predicted sign matches the sign of the coefficient to be coded, before the one or more magnitude symbols are predictively coded. The one or more symbols may be iteratively, predictively coded.

For example, before operation 3206 such as before operation 3202, the decoder may calculate a second cost for each of a plurality of second prediction candidates for predicting a sign of the coefficient and the magnitude symbol of the coefficient. Then, the decoder may select one of the plurality of second coefficient candidates as a coefficient sign predictor based on the second costs, similar to how the coefficient predictor is selected in operation 3204. The decoder entropy decodes a second indication of whether a value of the sign of the coefficient to be decoded matches a value of the sign of the coefficient sign predictor. After decoding the sign, the coefficient candidates for subsequent indications to be coded correspond to a subset of the plurality of second coefficient candidates. For example, the plurality of second coefficient candidates may include the plurality of coefficient candidates, and the second costs include the costs. For each subsequent indication to be coded, the coefficient candidates generated for a subsequent indication may have value(s) for symbol(s), corresponding to prior coded indication(s), equal to that of the coefficient to be coded. For example, the plurality of coefficient candidates may each have the value of the sign of the coefficient derived from the second indication and the coefficient sign predictor.

In a further example, for a subsequent, second magnitude symbol to be predictively coded after the magnitude symbol referenced in blocks 3202-3208, the plurality of coefficient candidates may include a plurality of third coefficient candidates to be used to predictively code the second magnitude symbol. For example, the third coefficient candidates may each have a value of the corresponding magnitude symbol equal to the determined value of the magnitude symbol of the coefficient at operation 3208. Likewise, the costs of operation 3202 may include second costs for the third coefficient candidates. Based on the second costs and similar to operations 3204-3208, the decoder may select one of the plurality of second coefficient candidates as a second coefficient predictor for predicting the second magnitude symbol of the coefficient. A second indication, of whether a second value of the second magnitude symbol of the coefficient to be decoded matches a second value of the second magnitude symbol of the second coefficient predictor, may be entropy decoded. Then, a value of the second magnitude symbol of the coefficient may be determined from the second indication and a value of the corresponding second magnitude symbol of the selected second coefficient predictor, similar to the process described above in operation 3208. It is to be understood that the encoder would reciprocally perform many of the same operations such as determining coefficient candidates for each symbol to be predictively coded, determining the costs for the coefficient candidates, and selecting a predictor (e.g., sign predictor or a coefficient predictor) from the coefficient candidates for each symbol. In contrast to determining a value of a symbol of the coefficient based on decoding the indication as performed by the decoder, the encoder generates and encodes the indication based on whether a value of the symbol of the coefficient to be encoded matches a value of the corresponding symbol of the predictor, as described above with respect to FIGS. 19A, 19B, and 31.

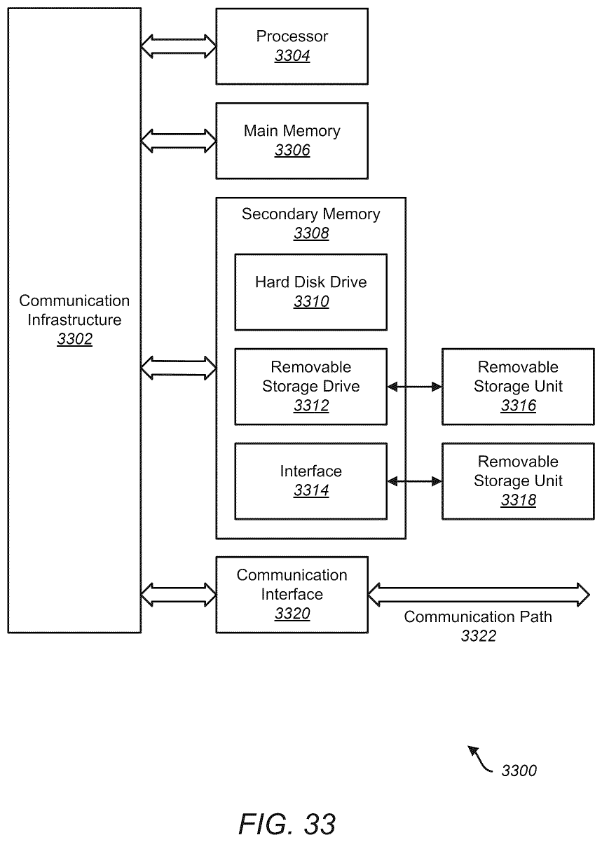

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 3300 is shown in FIG. 33. Blocks depicted in the figures above, such as the blocks in FIGS. 1, 2, and 3, may execute on one or more computer systems 3300. Furthermore, each of the steps of the flowcharts depicted in this disclosure may be implemented on one or more computer systems 3300.

Computer system 3300 includes one or more processors, such as processor 3304. Processor 3304 may be, for example, a special purpose processor, general purpose processor, microprocessor, or digital signal processor. Processor 3304 may be connected to a communication infrastructure 3302 (for example, a bus or network). Computer system 3300 may also include a main memory 3306, such as random access memory (RAM), and may also include a secondary memory 3308.

Secondary memory 3308 may include, for example, a hard disk drive 3310 and/or a removable storage drive 3312, representing a magnetic tape drive, an optical disk drive, or the like. Removable storage drive 3312 may read from and/or write to a removable storage unit 3316 in a well-known manner. Removable storage unit 3316 represents a magnetic tape, optical disk, or the like, which is read by and written to by removable storage drive 3312. As will be appreciated by persons skilled in the relevant art(s), removable storage unit 3316 includes a computer usable storage medium having stored therein computer software and/or data.

In alternative implementations, secondary memory 3308 may include other similar means for allowing computer programs or other instructions to be loaded into computer system 3300. Such means may include, for example, a removable storage unit 3318 and an interface 3314. Examples of such means may include a program cartridge and cartridge interface (such as that found in video game devices), a removable memory chip (such as an EPROM or PROM) and associated socket, a thumb drive and USB port, and other removable storage units 3318 and interfaces 3314 which allow software and data to be transferred from removable storage unit 3318 to computer system 3300.

Computer system 3300 may also include a communications interface 3320. Communications interface 3320 allows software and data to be transferred between computer system 3300 and external devices. Examples of communications interface 3320 may include a modem, a network interface (such as an Ethernet card), a communications port, etc. Software and data transferred via communications interface 3320 are in the form of signals which may be electronic, electromagnetic, optical, or other signals capable of being received by communications interface 3320. These signals are provided to communications interface 3320 via a communications path 3322. Communications path 3322 carries signals and may be implemented using wire or cable, fiber optics, a phone line, a cellular phone link, an RF link, and other communications channels.

As used herein, the terms “computer program medium” and “computer readable medium” are used to refer to tangible storage media, such as removable storage units 3316 and 3318 or a hard disk installed in hard disk drive 3310. These computer program products are means for providing software to computer system 3300. Computer programs (also called computer control logic) may be stored in main memory 3306 and/or secondary memory 3308. Computer programs may also be received via communications interface 3320. Such computer programs, when executed, enable the computer system 3300 to implement the present disclosure as discussed herein. In particular, the computer programs, when executed, enable processor 3304 to implement the processes of the present disclosure, such as any of the methods described herein. Accordingly, such computer programs represent controllers of the computer system 3300.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the art.

What is claimed is:

1. A method comprising:
calculating, for a transform coefficient to be decoded for a current block, a cost for each transform coefficient candidate of a plurality of transform coefficient candidates, wherein the plurality of transform coefficient candidates comprises:
a first transform coefficient candidate, and
a second transform coefficient candidate having a value of a magnitude symbol different from a value of the magnitude symbol of the first transform coefficient candidate;
selecting one of the plurality of transform coefficient candidates as a transform coefficient predictor based on the costs;
entropy decoding, from a bitstream, an indication of whether a value of the magnitude symbol of the transform coefficient predictor is correct and matches a value of the corresponding magnitude symbol of the transform coefficient to be decoded; and
determining, based on the indication and the value of the corresponding magnitude symbol of the transform coefficient predictor, the value of the magnitude symbol of the transform coefficient to be decoded to reconstruct the current block.

2. The method of claim 1, wherein the plurality of coefficient candidates is determined based on a number of most significant magnitude symbols of the transform coefficient that are to be predicted and decoded as indications of prediction correctness, wherein the plurality of coefficient candidates comprise all unique combinations of values for the number of the most significant magnitude symbols of the transform coefficient.

3. The method of claim 2, wherein the number of most significant magnitude symbols are of a suffix value of the transform coefficient, and wherein each transform coefficient candidate, of the plurality of transform coefficient candidates, comprise the same values for remaining magnitude symbols that are not one of the number of the most significant magnitude symbols.

4. The method of claim 1, wherein, for each transform coefficient candidate in the plurality of transform coefficient candidates, the cost is calculated based on an estimated energy difference on a block boundary of a coefficient group in which the transform coefficient to be decoded is located.

5. The method of claim 4, wherein the estimated energy difference on the block boundary is determined based on a difference between values of a plurality of reconstructed neighbor block samples adjacent to a boundary of the current block and predicted values of a plurality of samples adjacent to the boundary in the current block.

6. The method of claim 5, wherein the cost for each transform coefficient candidate is determined based on the estimated energy difference and the transform coefficients of the each transform coefficient candidate in transform domain.

7. The method of claim 6, wherein the estimated energy difference is determined further based on performing a one-dimensional transform of the difference from a spatial domain to the transform domain.

8. A video decoder comprising:
one or more processors; and
memory storing instructions that, when executed by the one or more processors, cause the video decoder to:
calculate, for a transform coefficient to be decoded for a current block, a cost for each transform coefficient candidate of a plurality of transform coefficient candidates, wherein the plurality of transform coefficient candidates comprises:
a first transform coefficient candidate, and
a second transform coefficient candidate having a value of a magnitude symbol different from a value of the magnitude symbol of the first transform coefficient candidate;
select one of the plurality of transform coefficient candidates as a transform coefficient predictor based on the costs;
entropy decode, from a bitstream, an indication of whether a value of the magnitude symbol of the transform coefficient predictor is correct and matches a value of the corresponding magnitude symbol of the transform coefficient to be decoded; and
determine, based on the indication and the value of the corresponding magnitude symbol of the transform coefficient predictor, the value of the magnitude symbol of the transform coefficient to be decoded to reconstruct the current block.

9. The video decoder of claim 8, wherein the plurality of coefficient candidates is determined based on a number of most significant magnitude symbols of the transform coefficient that are to be predicted and decoded as indications of prediction correctness, wherein the plurality of coefficient candidates comprise all unique combinations of values for the number of the most significant magnitude symbols of the transform coefficient.

10. The video decoder of claim 9, wherein the number of most significant magnitude symbols are of a suffix value of the transform coefficient, and wherein each transform coefficient candidate, of the plurality of transform coefficient candidates, comprise the same values for remaining magnitude symbols that are not one of the number of the most significant magnitude symbols.

11. The video decoder of claim 8, wherein, for each transform coefficient candidate in the plurality of transform coefficient candidates, the cost is calculated based on an estimated energy difference on a block boundary of a coefficient group in which the transform coefficient to be decoded is located.

12. The video decoder of claim 11, wherein the estimated energy difference on the block boundary is determined based on a difference between values of a plurality of reconstructed neighbor block samples adjacent to a boundary of the current block and predicted values of a plurality of samples adjacent to the boundary in the current block.

13. The video decoder of claim 12, wherein the cost for each transform coefficient candidate is determined based on the estimated energy difference and the transform coefficients of the each transform coefficient candidate in transform domain.

14. The video decoder of claim 13, wherein the estimated energy difference is determined further based on performing a one-dimensional transform of the difference from a spatial domain to the transform domain.

15. A non-transitory computer-readable medium comprising instructions that, when executed by one or more processors of a video decoder, cause the video decoder:
calculate, for a transform coefficient to be decoded for a current block, a cost for each transform coefficient candidate of a plurality of transform coefficient candidates, wherein the plurality of transform coefficient candidates comprises:
a first transform coefficient candidate, and
a second transform coefficient candidate having a value of a magnitude symbol different from a value of the magnitude symbol of the first transform coefficient candidate;
select one of the plurality of transform coefficient candidates as a transform coefficient predictor based on the costs;
entropy decode, from a bitstream, an indication of whether a value of the magnitude symbol of the transform coefficient predictor is correct and matches a value of the corresponding magnitude symbol of the transform coefficient to be decoded; and
determine, based on the indication and the value of the corresponding magnitude symbol of the transform coefficient predictor, the value of the magnitude symbol of the transform coefficient to be decoded to reconstruct the current block.

16. The non-transitory computer-readable medium of claim 15, wherein the plurality of coefficient candidates is determined based on a number of most significant magnitude symbols of the transform coefficient that are to be predicted and decoded as indications of prediction correctness, wherein the plurality of coefficient candidates comprise all unique combinations of values for the number of the most significant magnitude symbols of the transform coefficient.

17. The non-transitory computer-readable medium of claim 16, wherein the number of most significant magnitude symbols are of a suffix value of the transform coefficient, and wherein each transform coefficient candidate, of the plurality of transform coefficient candidates, comprise the same values for remaining magnitude symbols that are not one of the number of the most significant magnitude symbols.

18. The non-transitory computer-readable medium of claim 15, wherein, for each transform coefficient candidate in the plurality of transform coefficient candidates, the cost is calculated based on an estimated energy difference on a block boundary of a coefficient group in which the transform coefficient to be decoded is located.

19. The non-transitory computer-readable medium of claim 18, wherein the estimated energy difference on the block boundary is determined based on a difference between values of a plurality of reconstructed neighbor block samples adjacent to a boundary of the current block and predicted values of a plurality of samples adjacent to the boundary in the current block.

20. The non-transitory computer-readable medium of claim 19, wherein the cost for each transform coefficient candidate is determined based on the estimated energy difference and the transform coefficients of the each transform coefficient candidate in transform domain, and wherein the estimated energy difference is determined further based on performing a one-dimensional transform of the difference from a spatial domain to the transform domain.
